(19) United States
(12) Patent Application Publication
(10) Pub. No.: US 2026/0050190 A1
(43) Pub. Date: Feb. 19, 2026

(54) SYSTEM AND METHODS FOR ELECTROMAGNETIC STRUCTURES

(71) Applicant: Meta Platforms Technologies, LLC, Menlo Park, CA (US)

(72) Inventors: Salim Boutami, Seattle, WA (US); Mantas Zurauskas, Redmond, WA (US); Zhimin Shi, Bellevue, WA (US); Christophe Antoine Hurni, Seattle, WA (US); Gareth John Valentine, Kirkland, WA (US); James Ronald Bonar, Redmond, WA (US); Anurag Tyagi, Mill Creek, WA (US); Edward Buckley, High Peak (GB)

(21) Appl. No.: 18/747,086

(22) Filed: Jun. 18, 2024

(51) Int. Cl. G02F 1/13357; G02B 27/00

(52) U.S. Cl. CPC G02F 1/13362; G02B 27/0012; G02F 1/133602; G02F 1/133617

(57) ABSTRACT

An example method for improving a metasurface design may include providing a first wavefront; providing a library of metasurface elements, wherein each metasurface element has a variable phase response; creating a metasurface design by selecting metasurface elements via the library based on the first wavefront; simulating an electromagnetic response of the metasurface design; measuring a second wavefront based on the metasurface design; calculating an error between the first wavefront and the second wavefront; and generating a new phase profile by subtracting the error from the first wavefront and the second wavefront. Various other methods, systems, and computer-readable media are also disclosed.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a flow diagram of an example method for a metasurface design algorithm according to some embodiments.

FIG. 2 is an illustration of an example method for a metasurface design algorithm according to some embodiments.

FIG. 3 is an Illustration of the algorithm for improving metasurface design over iterations according to some embodiments.

FIG. 4 is a side view of schematic illustration for a single pixel with metasurface wavefront shaping element according to some embodiments.

FIG. 5 is a side view of a first device for metasurface characterization with active element for residual phase measurements according to some embodiments.

FIG. 6 is a side view of a second device for metasurface characterization with active element for residual phase measurements according to some embodiments.

FIG. 7 is a side view of a third device for metasurface characterization with active element for residual phase measurements according to some embodiments.

FIG. 8 is a diagram illustrating an exemplary display system that includes a laser-array-based backlight unit (BLU), according to some embodiments.

FIG. 9 is a diagram illustrating an exemplary display system that includes a laser-array-based BLU, according to some embodiments.

FIG. 10A is a diagram illustrating an exemplary extra-cavity color-converted vertical-cavity surface-emitting laser (VCSEL), according to some embodiments.

FIG. 10B is a diagram illustrating an exemplary extra-cavity color-converted VCSEL, according to some embodiments.

FIG. 11A is a diagram illustrating an exemplary extra-cavity color-converted VCSEL, according to some embodiments.

FIG. 11B is a diagram illustrating an exemplary extra-cavity color-converted VCSEL, according to some embodiments.

FIG. 12A is a diagram of a portion of an exemplary laser-array-based BLU that includes a light source and a beam-reshaping reflective element, according to some embodiments.

FIG. 12B is a diagram of a portion of an exemplary laser-array-based BLU that includes a light source and a beam-reshaping transmissive element, according to some embodiments.

FIG. 13 is a diagram of a portion of an exemplary laser-array-based BLU that includes a light source and an out-coupler, according to some embodiments.

FIG. 14 is a diagram of an exemplary assembly for manufacturing a display system having a laser-array-based BLU, according to some embodiments.

FIG. 15 is a flow diagram illustrating an example method of forming a display system, according to some embodiments.

FIG. 16 is an illustration of exemplary augmented-reality glasses that may be used in connection with embodiments of this disclosure.

FIG. 17 is an illustration of an exemplary virtual-reality headset that may be used in connection with embodiments of this disclosure.

FIG. 18 is a diagram illustrating an exemplary display system that includes a laser-array and color-conversion-module-based back light unit (BLU), according to some embodiments.

FIG. 19 is a diagram illustrating an exemplary display system that includes a laser-array and color-conversion-module-based BLU, according to some embodiments.

FIG. 20 is a diagram illustrating an exemplary vertical-cavity surface-emitting laser (VCSEL), according to some embodiments.

FIG. 21 is a diagram illustrating an exemplary color-converted VCSEL, according to some embodiments.

FIG. 22A is a diagram of a portion of an exemplary laser-array-based BLU that includes a light source and a beam-reshaping reflective element, according to some embodiments.

FIG. 22B is a diagram of a portion of an exemplary laser-array-based BLU that includes a light source and a beam-reshaping transmissive element, according to some embodiments.

FIG. 23 is a diagram of a portion of an exemplary laser-array-based BLU that includes a light source and an out-coupler, according to some embodiments.

FIG. 24A is a diagram of a portion of an exemplary laser-array-based and color-conversion-module-based BLU having a single pass color conversion configuration, according to some embodiments.

FIG. 24B is a diagram of a portion of an exemplary laser-array-based and color-conversion-module-based BLU having high reflectance and partial reflectance layers for enhanced conversion efficiency of blue light for conversion to red and green colors, according to some embodiments.

FIG. 25A is a diagram of a portion of an exemplary laser-array-based and color-conversion-module-based BLU having a reflector for better light extraction efficiency in red and/or green color conversion, according to some embodiments.

FIG. 25B is a diagram of a portion of an exemplary laser-array-based and color-conversion-module-based BLU having a reflective polarizer and quarter-wave plate (QWP) for polarization recycling in red and/or green color conversion, according to some embodiments.

FIG. 26A is a diagram of a portion of an exemplary laser-array-based and color-conversion-module-based BLU in which ultraviolet (UV) light is converted to red, green, and blue colors for corresponding pixels, according to some embodiments.

FIG. 26B is a diagram of a portion of an exemplary laser-array-based and color-conversion-module-based BLU in which UV light is converted to red, green, blue, and white colors for corresponding pixels, according to some embodiments.

FIG. 27 is a diagram of an exemplary assembly for manufacturing a display system having a laser-array and color-conversion-module-based BLU, according to some embodiments.

FIG. 28 is a flow diagram illustrating an example method of forming a display system, according to some embodiments.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

### Metasurface Design Optimization

The present disclosure is generally directed to systems and methods for metasurface nanostructure designs using an accurately targeted wavefront without increasing simulation requirements. When existing design techniques are used, metasurfaces may include a nanostructure grating with variable size and orientation. This variation may result in an infinitely periodic structure (e.g., grating) with a given pitch. A reflection/transmission of the amplitude/phase on such a grating may be measured after the grating is designed. Doing this process of designing a nanostructure grating and measuring the reflection/transmission for several structure sizes/orientations may then provide a library of individual variants of metasurface building blocks with known properties and arrangements of nanostructures providing a desired local amplitude/phase. This approximation may allow efficient computation, but it is not accurate, as nanostructures may have neighbors of varying sizes/orientations. In such an environment, the nanostructures may not exactly exhibit the same amplitude/phase shift as when they were in a periodic array. To mitigate such inaccuracies, this disclosure proposes to correct for wavefront distortions in metasurface design in an efficient manner by simulating the metasurface in as few iterations as required to get to an acceptable design and desired target wavefront. The number of iterations may not scale with the number of nanostructures, resulting in a numerically affordable design process.

Features from any of the embodiments described herein may be used in combination with one another in accordance with the general principles described herein. These and other embodiments, features, and advantages will be more fully understood upon reading the following detailed description in conjunction with the accompanying drawings and claims.

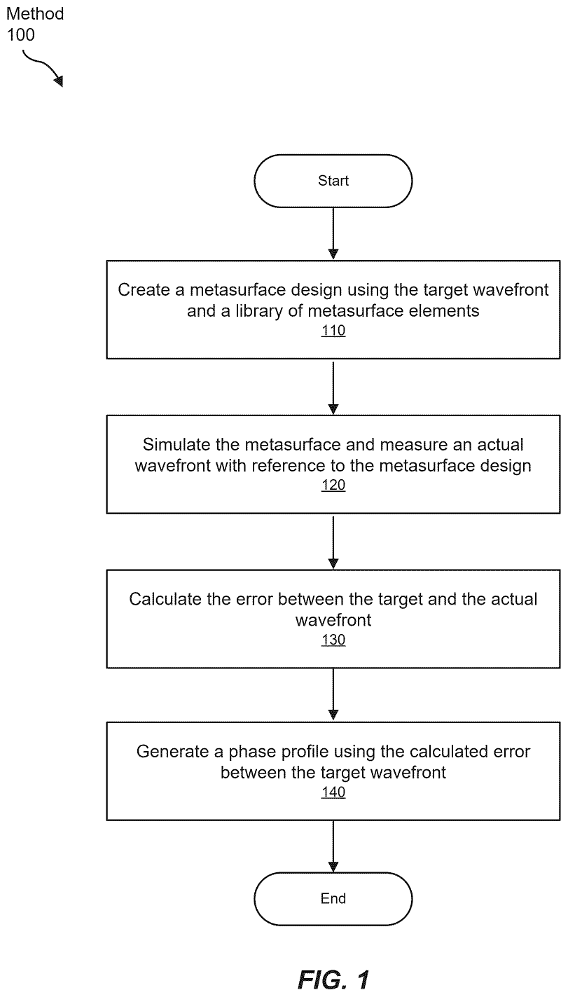

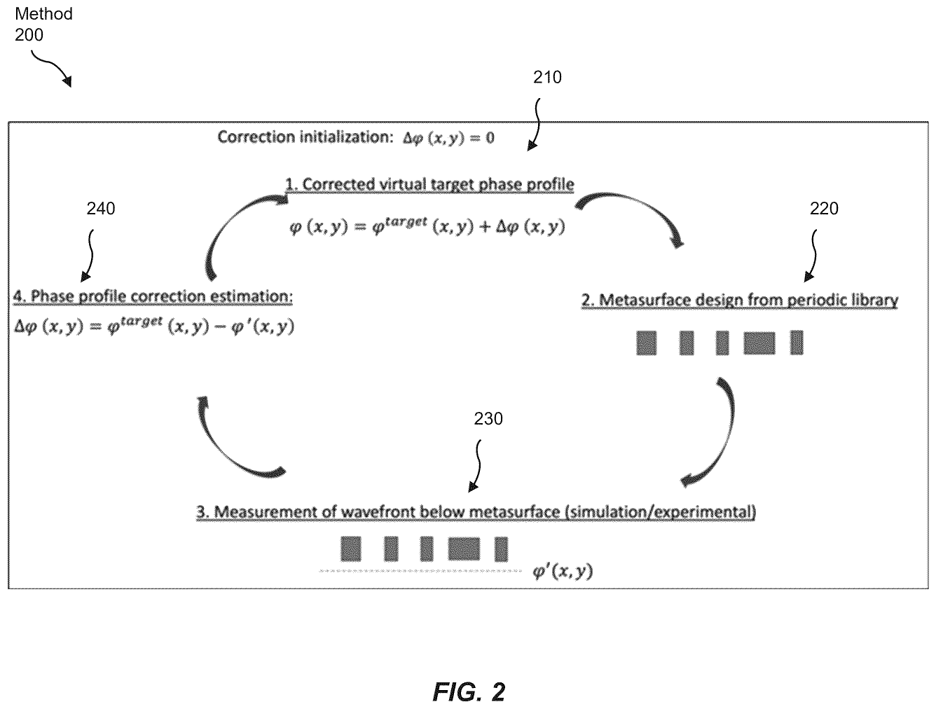

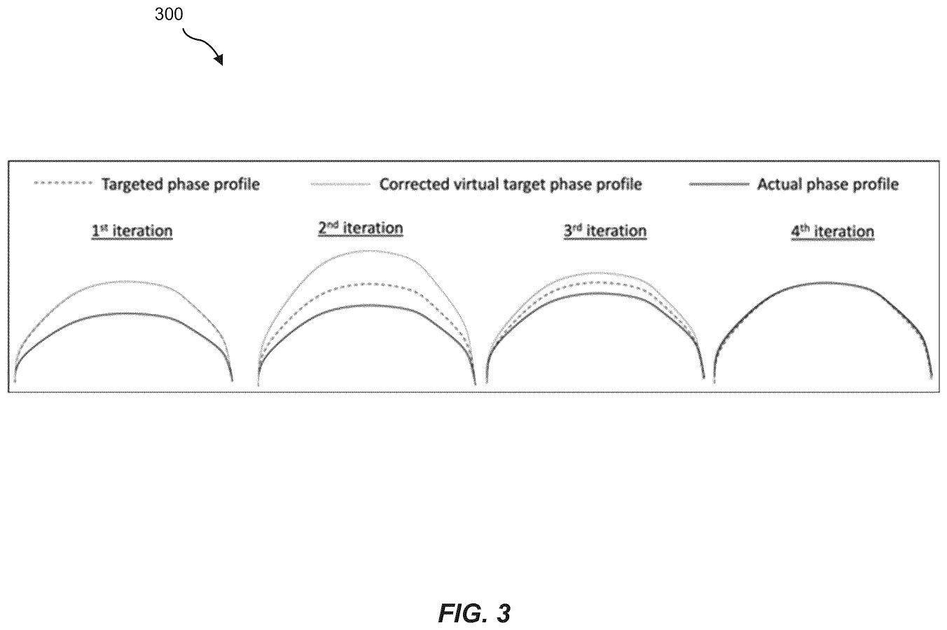

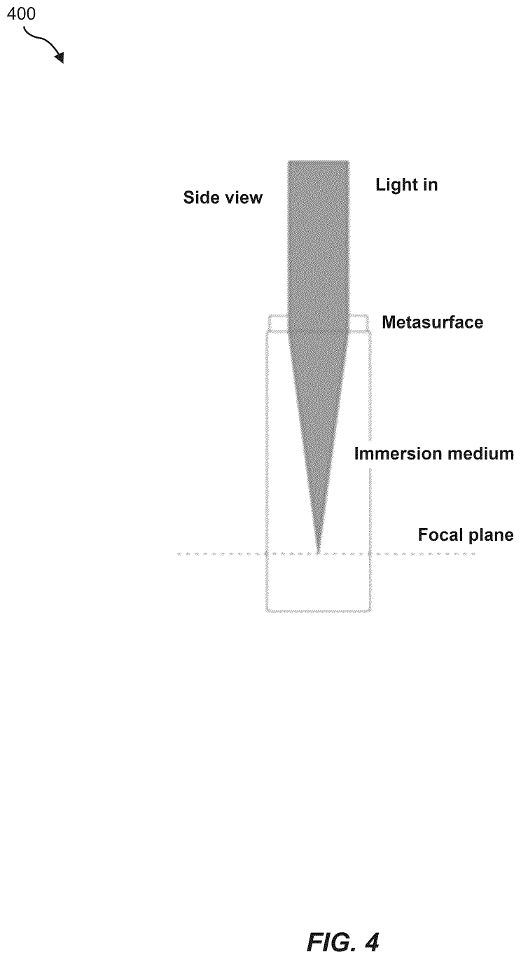

The following will provide, with reference to FIG. 1, a detailed description of a flow diagram of an example method for a metasurface design algorithm. The discussion corresponding to FIG. 2 highlights an illustration of an example method for a metasurface design algorithm. The discussion corresponding to FIG. 3 relates to an illustration of the algorithm for improving metasurface design over iterations. The discussion associated with FIGS. 4-7 relates to example devices for metasurface characterization methods.

FIG. 1 is a flow diagram of an example method 100 for a metasurface design algorithm. In one example, each of the steps shown in FIG. 1 may represent an algorithm whose structure includes and/or is represented by multiple sub-steps, examples of which will be provided in greater detail below.

Turning to FIG. 1, Method 100 includes several steps involved in algorithm loop for a metasurface design. As illustrated in FIG. 1, at step 110, a metasurface design may be created using a target wavefront and a library of metasurface elements, such as by selecting and arranging metasurface elements by the library based on the target wavefront. According to some embodiments, each metasurface element may have variable phase responses that may include nanostructures with varying sizes and orientations.

At step 120, a metasurface may be simulated and an actual wavefront, with reference to the metasurface design, may be measured. In one example, the simulation of the electromagnetic response may be performed using an entire area of the metasurface design. In certain embodiments, the simulation of the target wavefront and the actual wavefront may be performed by an active adaptive phase control device (e.g., a wavefront apparatus).

At step 130, an error between the target wavefront and the actual wavefront may be calculated. For example, the error between the target wavefront and the actual wavefront may be computed in both amplitude and phase.

At step 140, a virtual phase profile may be generated by subtracting the error from the target wavefront.

FIG. 2 illustrates an example method 200 for a metasurface design algorithm. The algorithm may be conducted in loop iterations to reach a design coverage of the metasurface such that the loop iterations may provide an expected phase output. In some examples, the algorithm corrects for inaccuracies of the library of metasurface elements.

At step 210, the algorithm loop may begin with a corrected virtual target phase profile algorithm, with a correction initialization as identified in FIG. 2. The corrected virtual target phase profile may be calculated using the algorithm shown in FIG. 2 at step 210.

At step 220, the algorithm loop may include generating a metasurface design by selecting metasurface elements from the periodic library.

At step 230, the algorithm loop may include measuring a wavefront below the metasurface. The measurement may be defined by either a simulated or an experimental metasurface design.

At step 240, the algorithm loop may include conducting a phase profile correction estimation for the metasurface design, by subtracting the measurement obtained at step 230 from the target phase profile, as expressed in FIG. 2 at step 240. The deviation (e.g., delta) of the phase profile obtained in step 240 may then be used to again obtain a corrected virtual target phase profile as shown at step 210.

The steps 210, 220, 230, and 240 of the algorithm loop may continue to be repeated in an iterative process until the phase profile correction estimation of step 240 results in a sufficiently small (e.g., below a predetermined threshold) phase profile correction, which may indicate that the measured wavefront below the metasurface of step 230 is the same as or close to the target phase profile. When this state is achieved, the metasurface design generated by selecting metasurface elements from the periodic library at step 220 may be utilized to form an actual metasurface that can achieve a desired optical performance.

FIG. 3 illustrates a plot 300 of four iterations of an algorithm for improving metasurface design, such as using the method 200 described above with reference to FIG. 2. For example, in a first iteration of the method 200, a targeted phase profile may be compared to an actual (e.g., measured or simulated) phase profile of a metasurface design selected from a library. A difference between the actual phase profile and the targeted phase profile from the first iteration may be used in a second iteration to select a second metasurface design from a library that may be closer to the targeted phase profile. Similarly, a third iteration and a fourth iteration may be performed until the actual phase profile of a selected metasurface design may be the same as, or close to (e.g., within a predetermined threshold from), the targeted phase profile, as shown in the plot 300 of FIG. 3.

Although FIG. 3 illustrates an example in which four iterations of the method 200 are performed to reach a desired phase profile of a metasurface design, the present disclosure is not so limited. In additional examples, fewer than four iterations or more than four iterations may be performed to reach a metasurface design with a phase profile that is sufficiently close to the target phase profile.

FIG. 4 is a side view of schematic illustration for a single-pixel structure 400 with a metasurface wavefront shaping element. The structure 400 may include a metasurface disposed over an immersion medium. As illustrated in FIG. 4, light entering the structure 400 may pass through the metasurface and into the immersion medium. The light may be focused by the metasurface onto a focal plane.

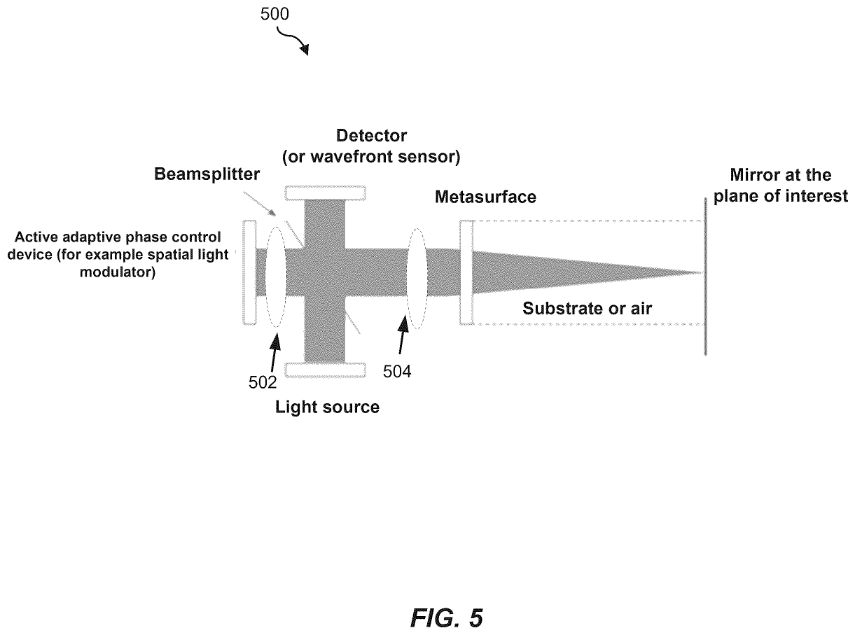

FIG. 5 is a side view of a first device 500 for metasurface characterization with active elements for residual phase measurements. In some examples, a light source may be positioned to direct light toward a beamsplitter. The beamsplitter may direct light from the light source to a first lens 502 and an active adaptive phase control device, such as a spatial light modulator. The active adaptive phase control device may direct light back toward the first lens 502 and through the beamsplitter to a wavefront sensor and a second lens 504. After passing through the second lens 504, the light may reach a metasurface, which may focus the light at a mirror at the plane of interest. A substrate or air may be positioned between the metasurface and the mirror at the plane of interest. The mirror in the plane of interest (e.g., for which the phase propagation change is known) may be used to fold the path, which is applicable to metasurfaces acting as lenses. By way of example, folding the path may refer to a technique that may enhance measurement sensitivity and accuracy of a metasurface's electromagnetic response. When a target phase profile is reached on the modulator, the metasurface may focus the light, and the wavefront measurement after folding may reproduce a phase profile of the modulator. This modulator profile then may provide a wavefront output error of the metasurface. In some examples, the first lens 502 and the second lens 504 may facilitate the conjunction of planes of the metasurface, the phase control device, and the correct magnification. In additional examples, the first lens 502 and the second lens 504 may be omitted.

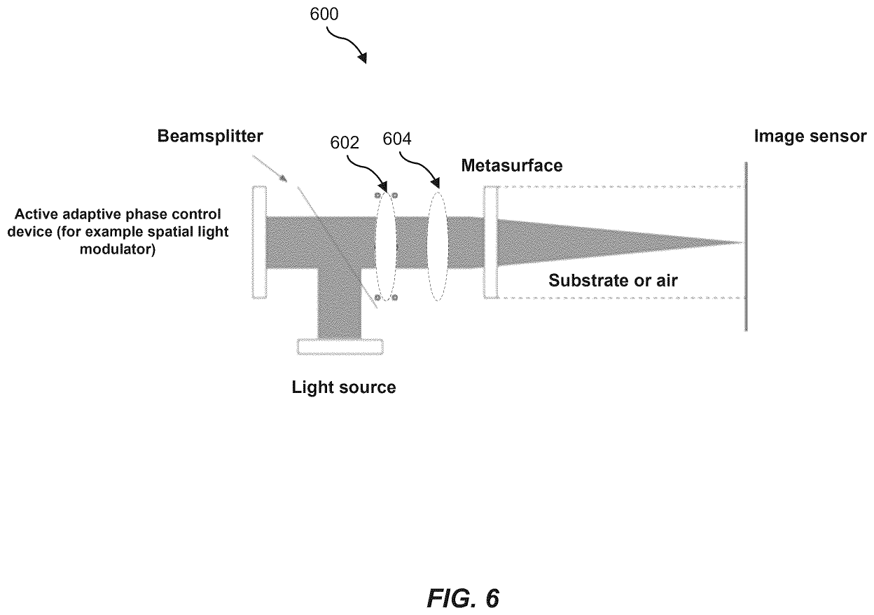

FIG. 6 is a side view of a second device 600 for metasurface characterization with an active element for residual phase measurements. In some examples, a light source may be positioned to direct light toward a beamsplitter. The beamsplitter may direct light from the light source to an active adaptive phase control device, such as a spatial light modulator. The active adaptive phase control device may direct light back toward and through the beamsplitter. The light may then reach a metasurface, which may focus the light at an image sensor. A substrate or air may be positioned between the metasurface and the image sensor. Optionally, a first lens 602 and a second lens 604 may be positioned between the beamsplitter and the metasurface, such as to facilitate conjunction of planes for the metasurface and the phase control device, and/or to correct magnification. Additionally, in some examples, the modulator may be tuned in such a manner that the image sensor depicts a suitable operation of the metasurface (e.g., an optical function of the metasurface: for example, for focusing the smallest spot, for light routing extinction ratio of a group of pixels, etc.). In other embodiments, the modulator phase profile may give an indication of a metasurface output wavefront error. Additionally, the second device 600 may include an intensity sensor (or intensity and phase sensor such as a plenoptic camera) that is positioned directly in a plane of interest.

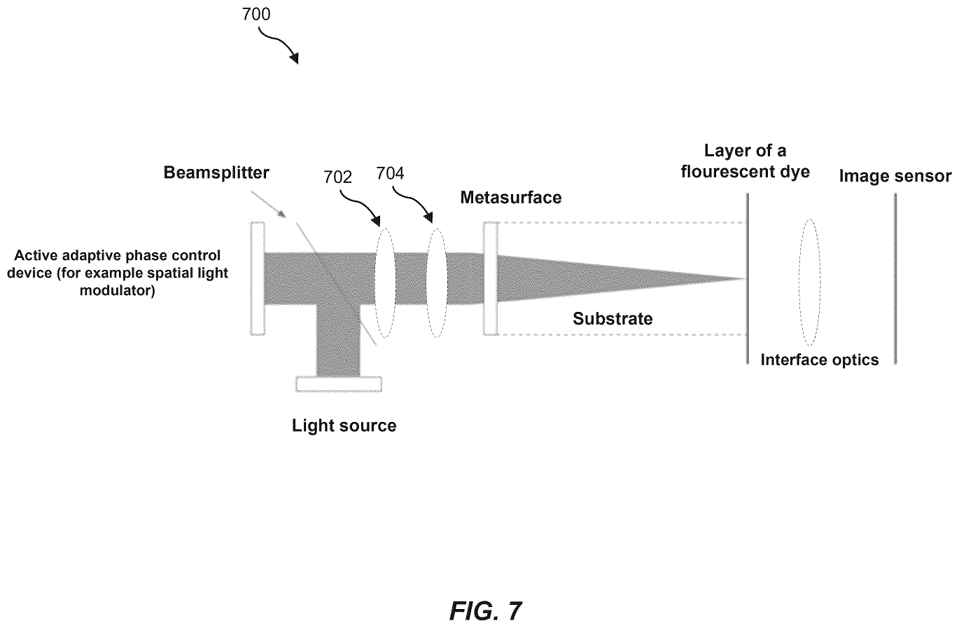

FIG. 7 is a side view of a third device 700 for metasurface characterization with active element for residual phase measurements. In some examples, the third device 700 may be similar to the second device 600 described above. However, as illustrated in FIG. 7, the third device 700 may include a layer of fluorescent dye through which light may pass prior to reaching an image sensor. The fluorescent dye layer may be imaged by an optics interface to a distant image sensor. Additionally, the fluorescent dye layer may be deposited on the back-end of a thinned substrate positioned adjacent to the metasurface and camera, or a microscope may be used to capture the intensity of the electromagnetic field.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of. ” Finally, for ease of use, the terms “including” and “having” (and their derivatives), as used in the specification and claims, are interchangeable with and have the same meaning as the word “comprising.”

### EXAMPLE EMBODIMENTS

Example 1: A method including (a) creating a metasurface design using a target phase profile of a target wavefront and a library of metasurface elements, (b) simulating the metasurface design, (c) determining a wavefront resulting from the metasurface design, (d) calculating an error between the target wavefront and the determined wavefront, (d) generating an updated phase profile using the calculated error.

Example 2: A method including (a) creating a metasurface design by selecting metasurface elements from a library of metasurface elements based on a first wavefront, (b) simulating an electromagnetic response of the metasurface design, (c) measuring a second wavefront based on the metasurface design (d) calculating an error between the first wavefront and the second wavefront, (e) generating a virtual phase profile by subtracting from the first wavefront, the calculated error between the first wavefront and the second wavefront.

Example 3: The method of example 2 where the library of metasurface elements includes plurality of nanostructure sizes and orientations.

Example 4: The method where the stimulation of the electromagnetic response is performed using an entire area of the metasurface design.

Example 5: The method of claim 2 where measuring the first wavefront and the second wavefront is performed by a wavefront apparatus.

Example 6: The method of claim 2 where the error between the first wavefront and the second wavefront is computed in both amplitude and phase.

### Display System Including Zonal Dimming Laser-Based Backlight Unit

Lasers have been looked to as light sources for display panels since they may provide higher brightness, higher directionality, and a larger color gamut in comparison to conventional light-emitting diodes (LEDs), mini-LEDs, organic light-emitting diodes (OLEDs), and other light sources. However, the delivery of laser light to the back of the display panels can present challenges. A conventional lightguide may couple light from the side, for example, resulting in challenges in light uniformity, light cone angle control, and polarization maintenance. An augmented-reality (AR) waveguide with a surface relief grating (SRG) or other diffractive optics delivery can present challenges in terms of uniformity and issues of interference between overlapping parts. Additionally, a photonic integrated circuit (PIC) single-mode waveguide-based delivery system may be undesirably expensive and may have no redundancy on a pixel-to-pixel level. It may also be difficult to implement local dimming on such a waveguide-based system. As a result, a laser-based backlight unit (BLU) architecture with zonal illumination capabilities may provide a highly desirable display light source.

The present disclosure is generally directed to display systems and devices that include laser-array-based BLUs that can provide segmented local dimming (i.e., zonal illumination) along with relatively high directionality, high polarization, and high throughput. Additionally, the described laser-array-based BLUs may provide illumination redundancy such that multiple light sources are available for each pixel. As disclosed herein, a BLU may primarily include an individually addressable laser array. In various examples, the BLU may also include a wavelength conversion module, a beam spot generation module, and/or one or more spacing layers.

Features from any of the embodiments described herein may be used in combination with one another in accordance with the general principles described herein. These and other embodiments, features, and advantages will be more fully understood upon reading the following detailed description in conjunction with the accompanying drawings and claims.

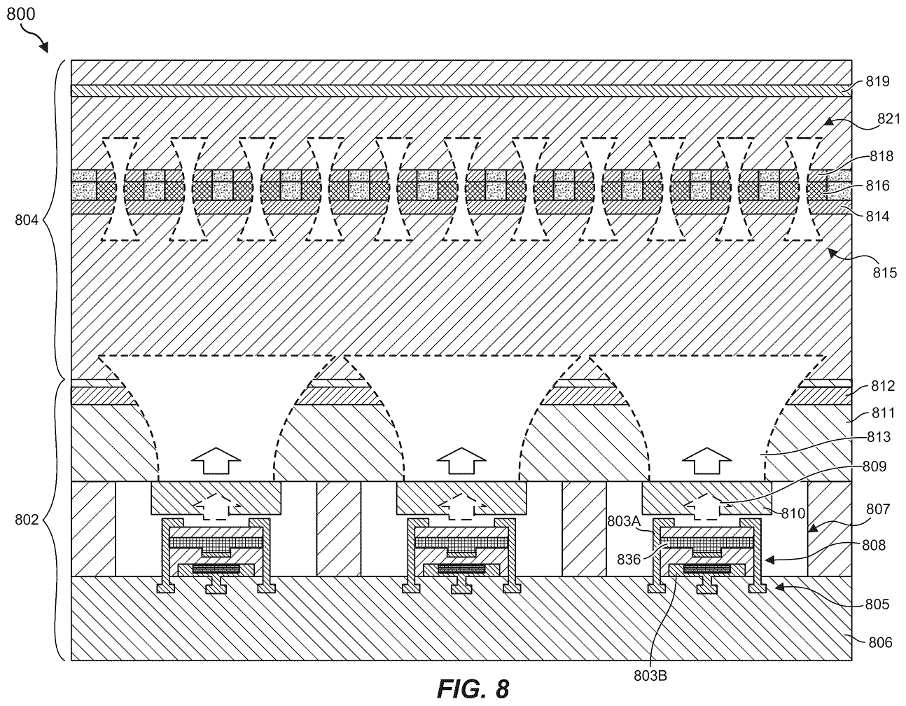

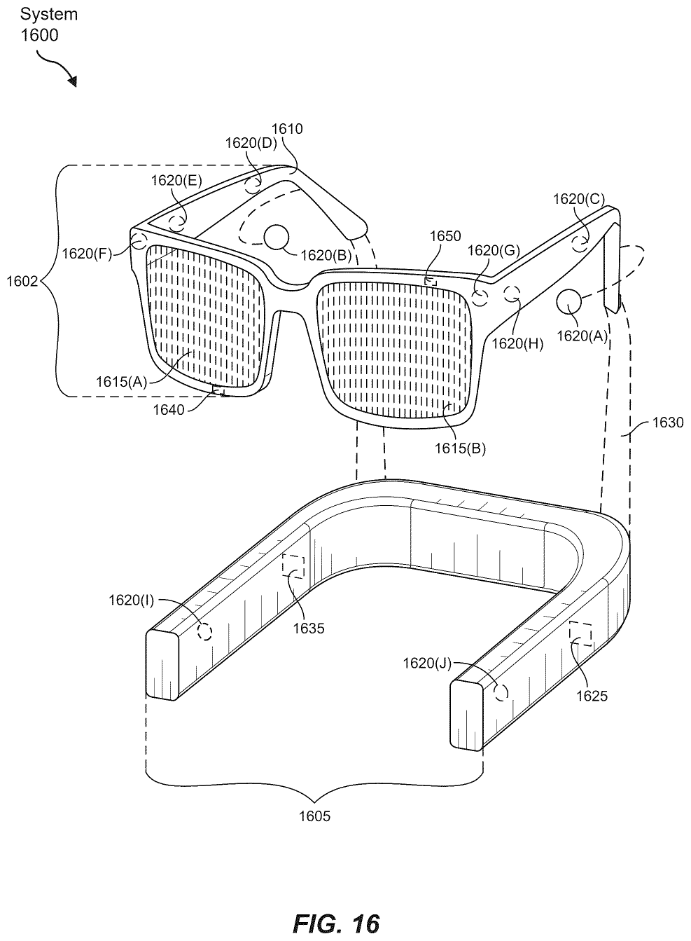

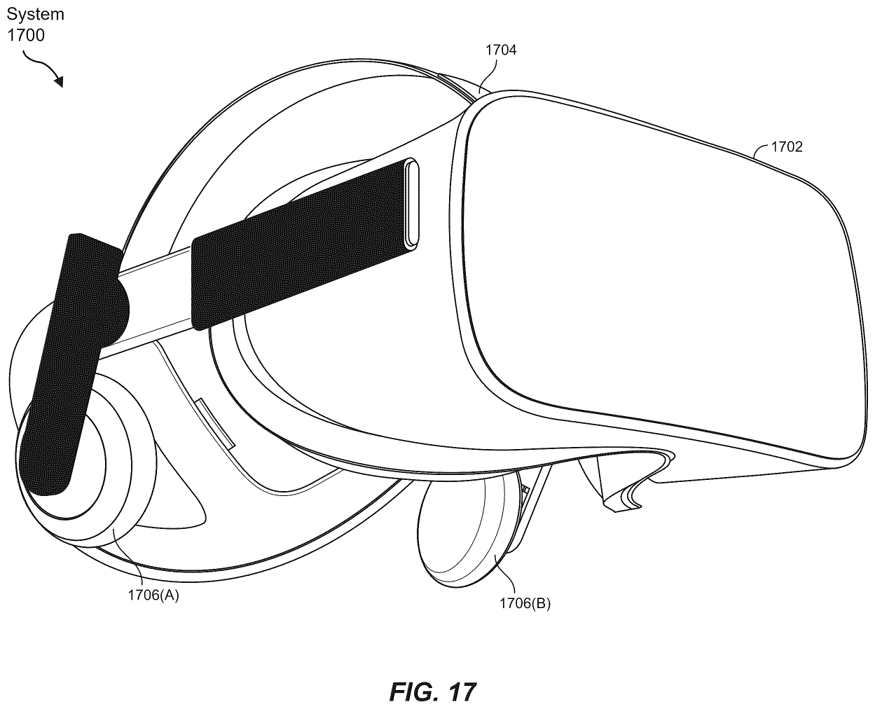

The following will provide, with reference to FIGS. 8-17, a detailed description of display systems and methods of manufacturing and using the same. The discussion associated with FIGS. 8-15 relates to the architecture, operation, and manufacturing of various example display systems and devices. The discussion associated with FIGS. 16 and 17 relates to exemplary virtual reality and augmented reality devices that may include display systems and devices as disclosed herein.

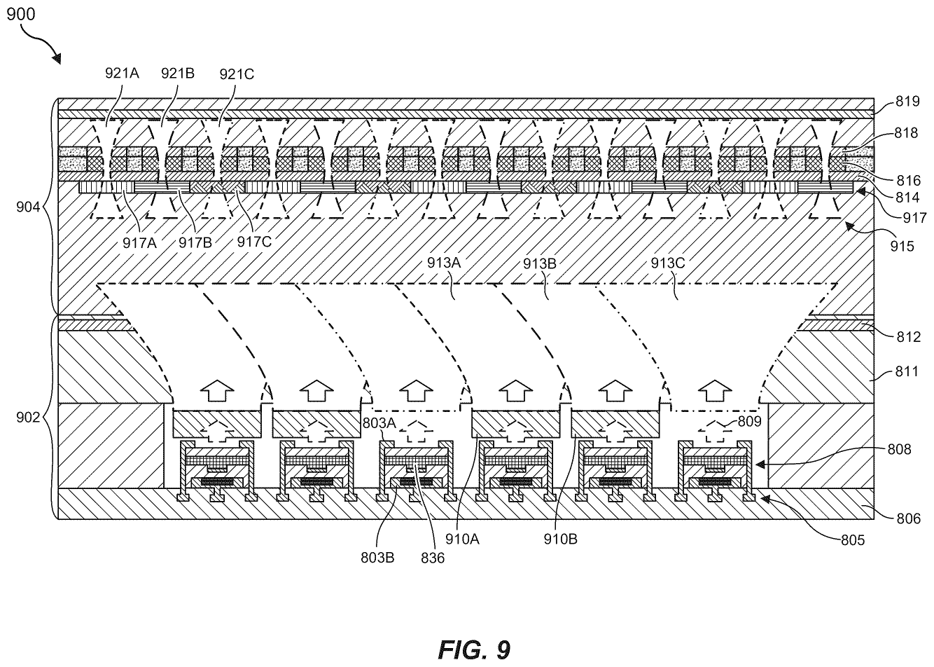

FIGS. 8 and 9 illustrate display systems 800 and 900 that each include a display panel overlapping a laser-array-based BLU, in accordance with various embodiments. As shown in FIG. 8, a laser-array-based BLU 802 may include an array of spatially coherent light sources, such as vertical-cavity surface-emitting lasers (VCSELs) 808, that generate and emit one or multiple wavelengths. While VCSELs 808 are illustrated in the display systems of FIGS. 8 and 9, BLUs 802 may additionally or alternatively contain arrays of other suitable laser and/or other light sources, including, for example, laser diodes, fiber lasers, heterogeneously integrated lasers, superluminescent diodes, and/or nonlinearly converted light sources. Nonlinearly converted light sources may include, for example, light beams from pump lasers converted using second harmonic generation (SHG), third harmonic generation (THG), four-wave mixing (FWM), difference frequency generation (DFG), parametric down-conversion (PDC), etc.

VCSELs and/or other spatially coherent light sources of laser-array-based BLU 802 may emit one or more colors of light and may be placed in a selected arrangement. In display system 800 illustrated in FIG. 8, the plurality of VCSELs 808 may be disposed on a substrate 806 that includes electronic circuitry for operating VCSELs 808. VCSELs 808 may be separated from each other by, for example, light-blocking members or walls extending between adjacent VCSELs 808. For example, VCSELs 808 may be disposed in cavities 807 defined in or on substrate 806. Display system 800 may display images having a single color or a plurality of colors (e.g., display system 800 may be an RGB system that includes red, green, and blue color pixels). In some examples, light beams 809 emitted by the VCSELs 808 may be converted to one or more other wavelengths of emitted light 813. For example, as shown in FIG. 8, light beams 809 from VCSELs 808 may pass through corresponding wavelength conversion modules 810 to convert light into one or more colors of emitted light 813 within a selected range(s) of wavelengths.

As shown in FIG. 8, laser-array-based BLU 802 may also include a beam spot generation module 812 that is placed over the array of VCSELs 808 and wavelength conversions modules 810. Beam spot generation module 812 may be spaced apart from the array of VCSELs 808 by a selected distance. For example, a spacer layer 811 may be disposed between the top of the array of wavelength conversion modules 810 and beam spot generation module 812. Incident light of each color from VCSELs 808/wavelength conversion modules 810 may then be diffracted by beam spot generation module 812 into an array of beam spots 815 that are each directed toward and/or focused at a selected plane of a display panel 804.

As shown in FIG. 8, display panel 804 (e.g., an LCD display panel) may be positioned over beam spot generation module 812 such that light of focused beam spots 815 from beam spot generation module 812 efficiently passes through pixel regions of display panel 804. Beam spots from beam spot generation module 812 may each cover one or multiple pixel/sub-pixel regions of display panel 804. As illustrated in FIG. 8, display panel 804 may include a liquid crystal material 816 and/or other active material for selectively blocking and/or otherwise modulating light (i.e., beam spots 815) from beam spot generation module 812. Display panel 804 may include an array of pixelated electrodes 818 disposed on one side of liquid crystal material 816 and one or more a common electrodes 814 disposed on an opposite side of liquid crystal material 816. Pixelated light 821 may be emitted from pixel regions of display panel 804. In various examples, display panel 804 may also include a polarizer 819 disposed over liquid crystal material 816 and pixelated electrodes 818/common electrode 814 such that pixelated light 821 is further polarized prior to emission from display panel 804.

FIG. 9 illustrates a display system 900 that includes a display panel 904 overlapping a laser-array-based BLU 902 in accordance with some embodiments. As shown, laser-array-based BLU 902 may include an array of spatially coherent light sources, such as an array of VCSELs 808 that emit one or more colors of light and may be placed in a selected arrangement. In some examples, light emitted by at least some of VCSELs 808 may be converted to one or more other wavelengths of light. For example, as shown in FIG. 9, light beams 809 from at least some of VCSELs 808 may pass through a corresponding wavelength conversion module 910A and/or 910B to convert the emitted light into one or more colors of light within a selected range(s) of wavelengths.

In some embodiments, laser-array-based BLU 902 may generate a plurality of light colors, such as red, green, and blue light beams that are directed to corresponding colored pixel/sub-pixel regions of display panel 904. VCSELs 808 may each emit light beams 809 having a specified wavelength or within a specified range of wavelengths. In at least one example, VCSELs 808 shown in FIG. 9 may each emit blue spectrum light beams 809 (i.e., light beams including wavelengths within a range from approximately 450 nm to approximately 495 nm). Blue light beams 809 from some of VCSELs 808 may be transmitted as emitted light 913C to beam spot generation module 812 directly without first passing through a wavelength conversion module. This blue light may be directed by beam spot generation module 812 to various display regions, including blue pixel/sub-pixel regions of display panel 904.

In this example, blue light beams 809 from additional VCSELs 808 may pass through selected wavelength conversion modules that convert the blue light to respective red and green light beams (or other suitable color light beams). For example, as shown in FIG. 9, light beams 809 from certain VCSELs 808 may pass through red wavelength conversion modules 910A to produce red emitted light 913A (i.e., emitted light including wavelengths within a range from approximately 620 nm to approximately 750 nm). Light beams 809 from other VCSELs 808 may pass through green wavelength conversion modules 910B to produce green emitted light 913B (i.e., emitted light including wavelengths within a range from approximately 495 nm to approximately 570 nm). The red and green emitted light 913A and 913B may be directed by beam spot generation module 812 to various display regions, including corresponding red and green pixel/sub-pixel regions of display panel 904.

In some examples, red emitted light 913A, green emitted light 913B, and blue emitted light 913C, and/or other suitable colors of light from VCSELs 808 and/or wavelength conversion modules 910A and 910B, may be combined in beam spot generation module 812 to produce an array of broadband light beams (e.g., white light beams) that are transmitted to display panel 904. As shown, display panel 904 (e.g., an LCD panel) may be positioned over beam spot generation module 812 such that light of each color efficiently passes through display panel 904. In some examples, display panel 904 may include a color filter 917 having red filter sections 917A, green filter sections 917B, and blue filter sections 917C (and/or other suitable color filter sections) overlapping corresponding pixel/sub-pixels regions of display panel 904. Color filter 917 may, for example, filter broadband light into red, green, and blue light at corresponding pixel/sub-pixel regions. In additional examples, VCSELs 808 utilized in laser-array-based BLUs may emit light directly at a desired visible wavelength(s). For example, laser-array-based BLU 902 may include separate red, green, and blue VCSELs 808.

As shown in FIG. 9, display panel 904 may include a liquid crystal material 816 and/or other active material for selectively blocking and/or otherwise modulating light (i.e., beam spots 915) from beam spot generation module 812. Pixelated light, including red pixelated light 921A, green pixelated light 921B, and blue pixelated light 921C may be emitted from pixel/sub-pixel regions of display panel 904. In various examples, display panel 904 may also include a polarizer 819 to polarize the red, green, and blue pixelated light 921A, 921B, and 921C prior to emission from display panel 904.

According to some embodiments, a polarization selection mechanism (e.g., a polarizer) may be placed outside of a VCSEL 808. Additionally or alternatively, a polarization selection mechanism (e.g., a polarizer) can be built within a VCSEL cavity (see, e.g., cavity 807 shown in FIG. 8). Such a polarization mechanism may, for example, include 1) a polarization dependent absorbing, scattering, diffracting, and/or reflecting material or structure, 2) a polarization dependent phase retarder, 3) a polarization dependent optical diffraction, refraction, or reflecting element (e.g., a lens, curved mirror, meta-lens, and/or meta-mirror), and/or 4) an etched structure that applies asymmetry to the VCSEL operation, such as an etched bar, etched grating, and/or semi-periodic structures.

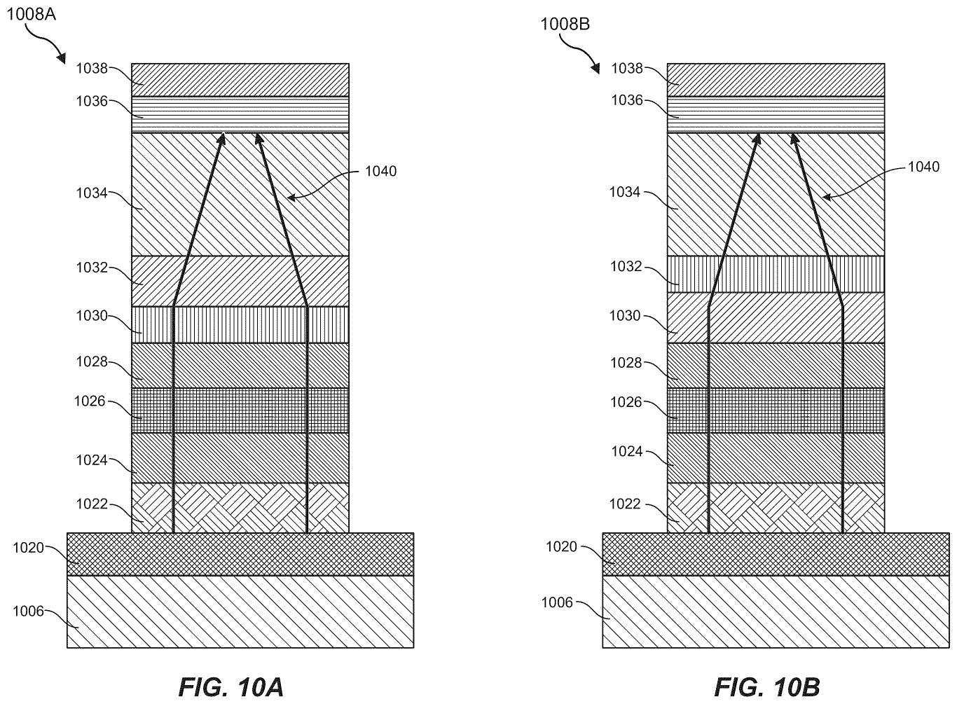

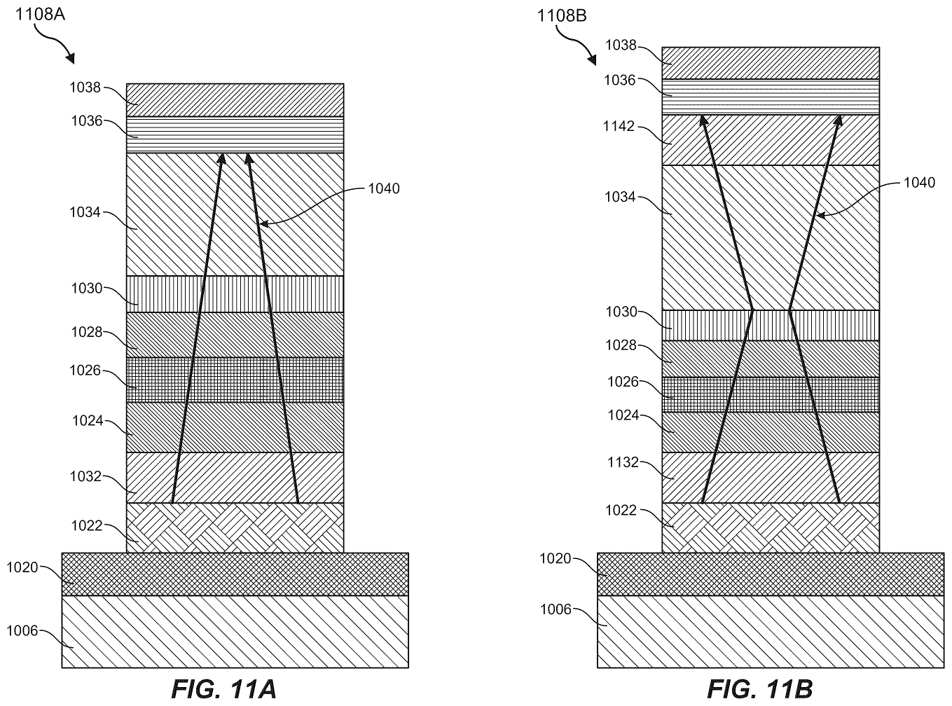

In various examples, the array of VCSELs 808 may have driving circuitry 805 directly integrated on and/or within substrate 806, as shown in FIGS. 8 and 9. In some examples, VCSELs 808 may each be configured with a first set of electrodes 803A in contact with one or more layers above a gain medium 836 and a second set of electrodes 803B in contact with one or more layers below gain medium 836 of the VCSEL 808 to allow injection current to go through gain medium 836 and generate light. First and second sets of electrodes 803A and 803B may each include one or more electrodes. The one or more layers above gain medium 836 may include at least a portion of a cladding layer, a focusing layer, and/or a multi-stack partial reflectance/high reflectance layer (see, e.g., FIGS. 10A-11B). The one or more layers below gain medium 836 may include at least a portion of another cladding, an HR layer, and/or a substrate (see, e.g., FIGS. 10A-11B).

VCSELs 808 may be integrated with or transferred onto substrate 806, which may be formed of one or more materials that can embed power, drive, and/or control circuits for VCSELs 808. Substrate 806 may include, for example, silicon (Si), gallium arsenide (GaAs), germanium (Ge), aluminum oxide (Al₂O₃), aluminum nitride (AlN), silicon carbide (SiC), and/or any other suitable semiconductor and/or other materials. In some examples, driving circuitry 805 within or on substrate 806 may additionally or alternatively impart other suitable functionality, such as providing electrical, thermal, and/or mechanical interface(s) for internal and/or external components.

A color-converted VCSEL 808 may include a VCSEL-based laser cavity that can generate light at a different wavelength than the desired visible wavelength. As described above in reference to FIG. 9, blue light may, for example, be produced by VCSELs 808 and converted to red and/or green light by respective red and green wavelength conversion modules 910A and 910B. Additionally or alternatively, any other suitable wavelengths of light may be generated by VCSELs 808 and may be converted to other selected colors of light by corresponding wavelength conversion modules. For example, a VCSEL 808 may generate a suitable wavelength within a near-infrared (NIR), visible, or ultraviolet (UV) light spectrum. VCSELs 808 may contain polarization selective elements, such as etched structures, polarization dependent absorption elements, and/or any other suitable elements. A color-conversion module (e.g., wavelength conversion module 810, 910A, or 910B) may convert emitted light from a VCSEL 808 at a given wavelength (e.g., NIR, UV, or visible light) into a desired visible wavelength (e.g., red, green, blue, etc.) for display panel 804. Wavelength conversion modules can be placed outside of or directly embedded within corresponding VCSEL cavities (see, e.g., the extra-cavity and/or intra-cavity designs shown in FIGS. 10A-11B). In some examples, wavelength conversion modules 810, 910A, and/or 910B may include polarization selective elements.

According to some embodiments, a color-conversion scheme of laser-array-based BLU 902 may include an NIR VCSEL 808 and one or more wavelength conversion modules utilizing second harmonic generation through a nonlinear optical crystal. In some examples, the color-conversion scheme may include a high-reflection coating for visible light embedded within the NIR VCSEL. To convert NIR light to visible light, a wavelength conversion module may contain one or more nonlinear materials and an optional high-reflection coating to enhance the nonlinear conversion efficiency. Nonlinear NIR to visible light conversion processes may include, for example, SHG, THG, high-order harmonic generation, FWM, etc. Processes to convert UV to visible light may include a wavelength conversion module having one or more nonlinear materials and an optional high-reflection coating to enhance the nonlinear conversion efficiency. Nonlinear UV to visible conversion processes may utilize Parametric down conversion, FWM, etc.

FIGS. 10A-11B illustrate various VCSEL configurations that may be utilized in display systems, such as display systems 800 and 900 shown in FIGS. 8 and 9, in accordance with various embodiments. The figures show exemplary extra-cavity VCSEL and/or intra-cavity VCSEL configurations. In various examples, VCSELs may be configured with one set of electric conducting layers in contact with one or more layers above a gain medium layer 1026 and another set of electric conducting layers in contact with one or more layers below gain medium layer 1026 to allow injection current to go through the gain medium and generate light.

FIGS. 10A and 10B show respective VCSEL assemblies 1008A and 1008B, in accordance with some embodiments. As shown in FIGS. 10A and 10B, layers above gain medium layer 1026 may include, for example, an upper cladding layer 1028, a focusing layer 1032, a wavelength (WL) converter layer 1034, and a multi-stack series of PR/HR layers that includes one or more partial-reflectance (PR), anti-reflectance (AR), and/or high-reflectance (HR) layers. Examples of PR/HR layers include a first PR/HR layer 1030 and a second PR/HR layer 1036. An optional visible beam shaper 1038 may also be disposed above gain medium layer 1026 on an upper region of VCSEL (e.g., above WL converter layer 1034 and/or second PR/HR layer 1036). Layers below gain medium layer 1026 may include a lower cladding layer 1024 and one or more HR layers, such as a stack that includes a first HR layer 1020 and a second HR layer 1022 disposed above a substrate 1006.

In at least one example, first PR/HR layer 1030 may partially reflect pumped light, including light generated in gain medium layer 1026 and reflected from first and second HR layers 1020 and 1022. A significant portion of pumped light generated by gain medium layer 1026 may be reflected by first and second HR layers 1020 and 1022 such that a substantial portion of the pumped light is directed away from substrate 1006. The pumped light generated by gain medium layer 1026 may have an initial light wavelength, such as a nonvisible wavelength (e.g., NIR, UV) or an initial visible wavelength (e.g., blue). Pump light rays 1040 illustrate paths of the pumped light between first HR layer 1022 and second PR/HR layer 1036.

First PR/HR layer 1030 may be partially reflective with respect to the pumped light such that at least a portion of the pumped light passes through first PR/HR layer 1030. Pumped light passing through first PR/HR layer 1030 may then proceed through WL converter layer 1034, which may convert substantially all or a significant portion of the pumped light into converted light having a different wavelength. Initial pumped light produced at gain medium layer 1026 may be converted by WL converter layer 1034 into a selected wavelength of visible light (e.g., red, green, blue, etc.). The initial pumped light produced at gain medium layer 1026 may be visible or nonvisible light, and the converted light generated in WL converter layer 1034 may be visible light.

According to various examples, light may be focused by focusing layer 1032 prior to passing through WL converter layer 1034, as shown in FIGS. 10A and 10B. According to at least one example, focusing layer 1032 may be disposed between first PR/HR layer 1030 and WL converter layer 1034, as shown in FIG. 10A. In another example, focusing layer 1032 may be disposed between upper cladding layer 1028 and first PR/HR layer 1030, as shown in FIG. 10B. In each of the examples shown in FIGS. 10A and 10B, pump light rays 1040 focused by focusing layer 1032 may be directed through WL converter layer 1034.

At least a portion of converted light rays produced by WL converter layer 1034 may pass through second PR/HR layer 1036. In at least one example, second PR/HR layer 1036 may be anti-reflective or partially reflective with respect to the converted light produced in WL converter layer 1034 so that at least a portion of the visible converted light passes through second PR/HR layer 1036. Visible converted light passing through second PR/HR layer 1036 may then be emitted from VCSEL assembly 1008A/1008B. In some examples, visible converted light from second PR/HR layer 1036 may be shaped by visible beam shaper 1038 prior to emission from VCSEL assembly 1008A/1008B.

Second PR/HR layer 1036 may be highly reflective with respect to unconverted pumped light from gain medium layer 1026 such that all or a substantial portion of the pumped light is reflected from second PR/HR layer 1036 back through WL converter layer 1034. Light reflected from second PR/HR layer 1036 may be directed back to first PR/HR layer 1030, where a substantial portion may again be reflected back through WL converter layer 1034 by first PR/HR layer 1030, which has high reflectivity with respect to the pumped light. Light may be cycled within VCSEL assemblies 1008A and 1008B, eventually being converted to a selected wavelength(s) of visible light and exiting from PR/HR layer 1036 and/or visible beam shaper 1038 toward display panel 804/904 (see FIGS. 8 and 9).

FIG. 11A shows a VCSEL assembly 1108A, in accordance with at least one embodiment. In the illustrated example, VCSEL assembly 1108A may include layers found in VCSEL assemblies 1008A and 1008B shown in FIGS. 10A and 10B. However, focusing layer 1032 of VCSEL assembly 1108A may be disposed below, rather than above, gain medium layer 1026 such that focusing layer 1032 is positioned between lower cladding layer 1024 and second HR layer 1022. In this example, pump light rays 1040 reflected by first and second HR layers 1020 and 1022 may be focused by focusing layer 1032 such that pump light rays 1040 pass through gain medium layer 1026 toward WL converter layer 1034.

FIG. 11B shows a VCSEL assembly 1108B, in accordance with at least one embodiment. As shown, VCSEL assembly 1108B may include a plurality of focusing layers, including a lower focusing layer 1132 disposed below gain medium layer 1026 and an upper focusing layer 1142 disposed above WL converter layer 1034, as illustrated in FIG. 11B. The multiple focusing layers 1132 and 1142 may direct light in a selected manner within and outward from VCSEL assembly 1108B, as illustrated.

While layers of respective VCSEL assemblies 1008A/1008B/1108A/1108B may be stacked in contact with or in close proximity to each other, as illustrated in FIGS. 10A-11B, at least some of the layers may be separated from each other. For example, as illustrated in FIGS. 8-9, wavelength conversion modules 810, 910A, and/or 910B may be separated from lower portions of VCSELs 808. Additionally, wavelength conversion modules 810, 910A, and/or 910B and/or other VCSEL components may be disposed within or outside of a corresponding VCSEL cavity 807. According to various embodiments, one or more of the layers of VCSEL assemblies 1008A/1008B/1108A/1108B shown in FIGS. 10A-11B may exhibit polarization dependence.

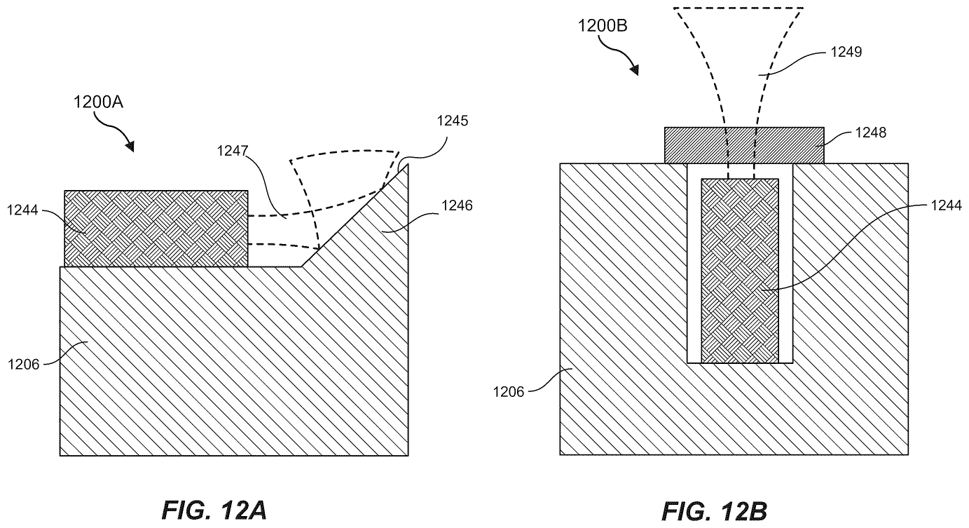

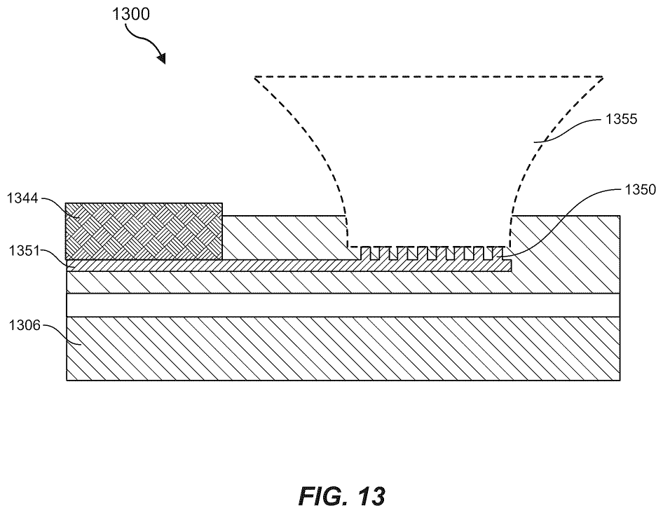

FIGS. 12A-13 illustrate various examples of light sources and beam distribution components that may be utilized in BLUs of display systems, such as those disclosed herein. In some embodiments, a beam reshaping element may be a reflective or transmissive type, or the beam reshaping element may combine both reflective and transmissive elements. Additional phase front modulation features may also be included so that each emitted beam can achieve a selected spatial profile when it reaches a beam spot array generation module (see, e.g., beam spot generation module 812 in FIGS. 8 and 9).

In one example, a portion of a laser-array-based BLU 1200A, as shown in FIG. 12A, may include at least one light source 1244 (e.g., a laser source) that emits a beam of light 1247 in a direction that is parallel or substantially parallel to a planar surface of a substrate 1206. Light 1247 emitted by light source 1244 may be reflected toward a beam spot generation module (e.g., beam spot generation module 812 in FIGS. 8 and 9) by a beam-reshaping reflective element 1246 having a reflective surface 1245 that is sloped at a selected angle with respect to substrate 1206. Beam-reshaping reflective element 1246 may spread the beam of light 1247 to widen the coverage area of light from the beam.

FIG. 12B shows a portion of a laser-array-based BLU 1200B that includes at least one light source 1244 (e.g., a laser source) disposed in a cavity defined in a substrate 1206. As shown, a beam of light 1249 emitted by light source 1244 may pass through a transmissive beam-reshaping element 1248, which may spread the beam of light 1249 to widen a coverage region of light from the beam. Reflective and/or transmissive type beam-reshaping elements, such as those shown in FIGS. 12A and 12B, may add additional phase front modulation so the emitted beams can reach a desired spatial profile when they reach a beam spot array generation module (e.g., beam spot generation module 812 in FIGS. 8 and 9).

According to at least one embodiment, a light source may be placed in the vicinity of one or more BLU zones. FIG. 13 shows, for example, a portion of a laser-array-based BLU 1300 that includes at least one light source 1344 (e.g., a laser source) disposed on a substrate 1306. In the example shown in FIG. 13, light emitted by the light source 1344 may be coupled into a waveguide 1351 or other type of light guide. The light may propagate through waveguide 1351 to an out-coupler 1350, which then emits light 1355 vertically or substantially vertically relative to substrate 1306. As illustrated in FIG. 13, out-coupler 1350 may emit an expanded region of light 1355 from various exit regions of out-coupler 1350.

According to various embodiments, a beam spot generation module (see, e.g., beam spot generation module 812 in FIGS. 8 and 9) may take an output beam profile (e.g., an approximately Gaussian-like profile, etc.) from one or more light sources (e.g., VCSELs 808/1008A/1008B/1108A/1108B in FIGS. 8-11B) after a certain propagation distance (e.g., from approximately 10 μm to approximately 1 mm). In at least one example, the beam spot generation module may generate a specific array of uniform or quasi-uniform spots that match a pixel/sub-pixel arrangement pattern (e.g., RGB stripe, RGBG, RGBW, pentile RGBG) of an LCD display (e.g., display panel 804/904 in FIGS. 8 and 9) at a given distance (e.g., approximately 50 μm to to approximately 1 mm). The pattern of uniform/quasi-uniform spots may propagate through the display panel to produce a pixel-based image.

In some embodiments, the respective beam spot arrays for different colors can be spatially different and may be separated to match sub-pixel arrangements (e.g., RGB stripe, RGBG, RGBW, pentile RGBG) of the display panel. A center location of the spot arrays for different colors can also be identical and may spatially overlap to meet pixel arrangements of color-multiplexing-based display panels. In at least one embodiment, portions of a beam spot generation module in front of different VCSELs within a segment may be designed differently so as to generate spatially-overlapping beam spot arrays at a desired plane. Such spatially-overlapping beam spot arrays may provide lighting redundancy, enabling light to be provided to each pixel/sub-pixel, even when one or more of the VCSELs are non-operational. A beam spot generation module (see, e.g., beam spot generation module 812 in FIGS. 8 and 9), as described herein, may include one or more of 1) a meta-surface, 2) a diffractive optical element, 3) a holographic optical element, 4) a volume holographic optical element, and/or 5) a micro-lens array.

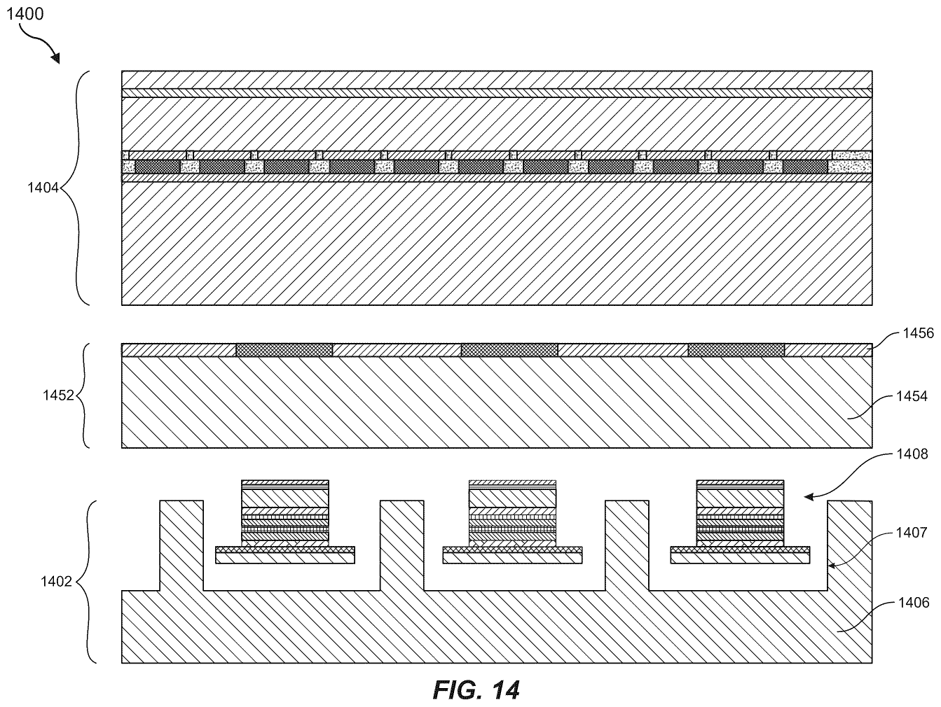

FIG. 14 shows an exemplary assembly 1400 for a display system (e.g., display system 800/900 shown in FIGS. 8 and 9), according to some embodiments. A display system, as disclosed herein, may be assembled in any suitable manner. For example, VCSELs 1408 may first be fabricated prior to coupling VCSELs 1408 to a first substrate 1406. In some examples, WL conversion modules may be co-fabricated with other elements/layers of VCSELs 1408 (e.g., color-converted VCSELs) depending on the specific stack design (see, e.g., FIGS. 10A-11B). First substrate 1406 for mounting VCSELs 1408 may be fabricated with driving circuits (see, e.g., circuitry 805 in FIGS. 8 and 9) as well as mechanical stops for VCSELs 1408, which may include color-converted VCSELs. VCSELs 1408 may be picked and selectively placed onto first substrate 1406 in any suitable manner (e.g., via integrated circuit mounting, thermal attachment, etc.) to form an array of VCSELs 1408 for assembly 1400. In some examples, VCSELs 1408, or at least a portion thereof, may be disposed within corresponding cavities 1407.

A beam spot generation portion 1452 may be formed separately from VCSEL portion 1402 of assembly 1400. To manufacture beam spot generation portion 1452, diffractive optical elements (DOEs) and/or holographic optical elements (HOEs 1456) may be fabricated as a DOE/HOE layer 1456 on a second substrate 1454 that is separate from VCSEL portion 1402. DOE/HOE layer 1456 may act as a beam spot generation module (see, e.g., beam spot generation module 812 in FIGS. 8 and 9) that is used to direct light from VCSELs 1408 to display panel 1404 overlapping beam spot generation portion 1452 and VCSEL portion 1402.

Beam spot generation portion 1452, which includes second substrate 1454 combined with DOE/HOE layer 1456, may be laminated onto VCSEL portion 1402, which includes VCSELs 1408 mounted on first substrate 1406. In some examples, VCSELs 1408 may be combined with first substrate 1406 to form VCSEL portion 1402 and DOE/HOE layer 1456 may be separately combined with second substrate 1454 to form beam spot generation portion 1452. Beam spot generation portion 1452 may then be laminated onto VCSEL portion 1402 with, for example, passive alignment to produce a laser-array-based BLU (see, e.g., laser-array-based BLUs 802/902 in FIGS. 8 and 9). Display panel 1404, which may include a liquid crystal display panel, may then be laminated onto a top surface of DOE/HOE layer 1456 with passive or active alignment. Active alignment in this example may refer to turning on one or more VCSELs 1408 during layer alignment.

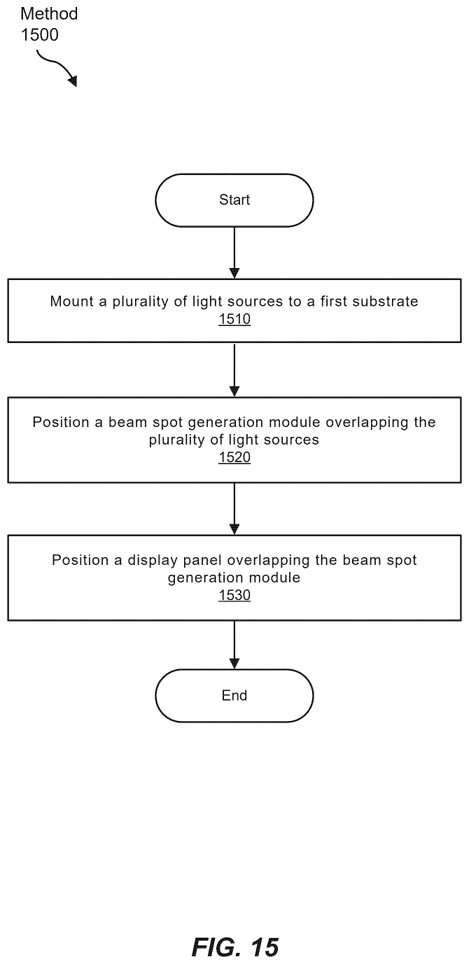

FIG. 15 is a flow diagram illustrating a method 1500 of fabricating a display system according to at least one embodiment of the present disclosure. At operation 1510, a plurality of light sources may be mounted to a first substrate. For example, a plurality of VCSELs 1408 may be mounted to a first substrate 1406 (see FIG. 14; see also FIGS. 8 and 9). Operation 1510 may be performed in a variety of ways. For example, the plurality of light sources (e.g., VCSELs and/or other laser light sources) may be coupled to portions (e.g., within cavities) of the first substrate. The first substrate may include wiring to drive the mounted light sources.

At operation 1520, a beam spot generation module may be positioned overlapping the plurality of light sources. Operation 1520 may be performed in a variety of ways. For example, a beam spot generation portion 1452 may include a beam spot generation module (e.g., a DOE/HOE layer 1456) disposed on a second substrate 1406 (see FIG. 14; see also FIGS. 8 and 9). The second substrate may be laminated on the first substrate overlapping the plurality of light sources such that light from the light sources is redirected by the beam spot generation module to form an array of beams spots.

At operation 1530, a display panel may be positioned overlapping the beam spot generation module. Operation 1530 may be performed in a variety of ways. For example, a display panel 1404 may be positioned over the beam spot generation module (e.g., DOE/HOE layer 1456) such that an array of beam spots produced by the beam spot generation module are directed to corresponding pixel/sub-pixel regions of display panel 1404 (see FIG. 14; see also FIGS. 8 and 9).

The present disclosure includes display systems, devices, and methods that include laser-array-based BLUs overlapping display panels. As described, the laser-array-based BLUs may have selective zonal illumination capabilities that enable segmented local dimming (i.e., zonal illumination), high directionality, high polarization, and high throughput. Additionally, in some embodiments, the described laser-array-based BLUs may provide redundancy such that multiple light sources may be available to provide light for each pixel/sub-pixel region.

Accordingly, the disclosed display systems may provide desirable display features while allowing for minimal power usage through selective zonal illumination. For example, local dimming of unused portions of the display area may be utilized to manage power saving and offer a high dynamic range display. Laser-array-based BLUs having directional polarized output may provide high illumination efficiency. Additionally, focused beam spots produced at the display panel plane by a beam spot generation module may provide high light throughput. As such, accurate (e.g., pixel-level) alignment between light emitting portions of the laser-array-based BLU and the beam spot generation module may not be needed, facilitating simplified assembly of the system.

The disclosed system may have the merit of serving many applications, including augmented/virtual reality (AR/VR), robotics, and health care, in addition to many other applications. For instance, in AR environments, the systems described herein may play the audio elements and/or display the visual elements so that a user may view the integration of artificial graphics with the user's natural surroundings. This system can provide graphical guidance about which object is emitting sound in the user's field of view and enhance his/her experience of interaction in the AR environment. Moreover, this system can help robot navigation and predict human health conditions, etc.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1600 in FIG. 16) or that visually immerses a user in an artificial reality (such as, e.g., virtual-reality system 1700 in FIG. 17). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 16, augmented-reality system 1600 may include an eyewear device 1602 with a frame 1610 configured to hold a left display device 1615(A) and a right display device 1615(B) in front of a user's eyes. Display devices 1615(A) and 1615(B) may act together or independently to present an image or series of images to a user. While augmented-reality system 1600 includes two displays, embodiments of this disclosure may be implemented in augmented-reality systems with a single NED or more than two NEDs.

In some embodiments, augmented-reality system 1600 may include one or more sensors, such as sensor 1640. Sensor 1640 may generate measurement signals in response to motion of augmented-reality system 1600 and may be located on substantially any portion of frame 1610. Sensor 1640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1600 may or may not include sensor 1640 or may include more than one sensor. In embodiments in which sensor 1640 includes an IMU, the IMU may generate calibration data based on measurement signals from sensor 1640. Examples of sensor 1640 may include, without limitation, accelerometers, gyroscopes, magnetometers, other suitable types of sensors that detect motion, sensors used for error correction of the IMU, or some combination thereof.

In some examples, augmented-reality system 1600 may also include a microphone array with a plurality of acoustic transducers 1620(A)-1620(J), referred to collectively as acoustic transducers 1620. Acoustic transducers 1620 may represent transducers that detect air pressure variations induced by sound waves. Each acoustic transducer 1620 may be configured to detect sound and convert the detected sound into an electronic format (e.g., an analog or digital format). The microphone array in FIG. 16 may include, for example, ten acoustic transducers: 1620(A) and 1620(B), which may be designed to be placed inside a corresponding ear of the user, acoustic transducers 1620(C), 1620(D), 1620(E), 1620(F), 1620(G), and 1620(H), which may be positioned at various locations on frame 1610, and/or acoustic transducers 1620(I) and 1620(J), which may be positioned on a corresponding neckband 1605.

In some embodiments, one or more of acoustic transducers 1620(A)-(J) may be used as output transducers (e.g., speakers). For example, acoustic transducers 1620(A) and/or 1620(B) may be earbuds or any other suitable type of headphone or speaker.

The configuration of acoustic transducers 1620 of the microphone array may vary. While augmented-reality system 1600 is shown in FIG. 16 as having ten acoustic transducers 1620, the number of acoustic transducers 1620 may be greater or less than ten. In some embodiments, using higher numbers of acoustic transducers 1620 may increase the amount of audio information collected and/or the sensitivity and accuracy of the audio information. In contrast, using a lower number of acoustic transducers 1620 may decrease the computing power required by an associated controller 1650 to process the collected audio information. In addition, the position of each acoustic transducer 1620 of the microphone array may vary. For example, the position of an acoustic transducer 1620 may include a defined position on the user, a defined coordinate on frame 1610, an orientation associated with each acoustic transducer 1620, or some combination thereof.

Acoustic transducers 1620(A) and 1620(B) may be positioned on different parts of the user's ear, such as behind the pinna, behind the tragus, and/or within the auricle or fossa. Or, there may be additional acoustic transducers 1620 on or surrounding the ear in addition to acoustic transducers 1620 inside the ear canal. Having an acoustic transducer 1620 positioned next to an ear canal of a user may enable the microphone array to collect information on how sounds arrive at the ear canal. By positioning at least two of acoustic transducers 1620 on either side of a user's head (e.g., as binaural microphones), augmented-reality device 1600 may simulate binaural hearing and capture a 3D stereo sound field around about a user's head. In some embodiments, acoustic transducers 1620(A) and 1620(B) may be connected to augmented-reality system 1600 via a wired connection 1630, and in other embodiments acoustic transducers 1620(A) and 1620(B) may be connected to augmented-reality system 1600 via a wireless connection (e.g., a BLUETOOTH connection). In still other embodiments, acoustic transducers 1620(A) and 1620(B) may not be used at all in conjunction with augmented-reality system 1600.

Acoustic transducers 1620 on frame 1610 may be positioned in a variety of different ways, including along the length of the temples, across the bridge, above or below display devices 1615(A) and 1615(B), or some combination thereof. Acoustic transducers 1620 may also be oriented such that the microphone array is able to detect sounds in a wide range of directions surrounding the user wearing the augmented-reality system 1600. In some embodiments, an optimization process may be performed during manufacturing of augmented-reality system 1600 to determine relative positioning of each acoustic transducer 1620 in the microphone array.

In some examples, augmented-reality system 1600 may include or be connected to an external device (e.g., a paired device), such as neckband 1605. Neckband 1605 generally represents any type or form of paired device. Thus, the following discussion of neckband 1605 may also apply to various other paired devices, such as charging cases, smart watches, smart phones, wrist bands, other wearable devices, hand-held controllers, tablet computers, laptop computers, other external compute devices, etc.

As shown, neckband 1605 may be coupled to eyewear device 1602 via one or more connectors. The connectors may be wired or wireless and may include electrical and/or non-electrical (e.g., structural) components. In some cases, eyewear device 1602 and neckband 1605 may operate independently without any wired or wireless connection between them. While FIG. 16 illustrates the components of eyewear device 1602 and neckband 1605 in example locations on eyewear device 1602 and neckband 1605, the components may be located elsewhere and/or distributed differently on eyewear device 1602 and/or neckband 1605. In some embodiments, the components of eyewear device 1602 and neckband 1605 may be located on one or more additional peripheral devices paired with eyewear device 1602, neckband 1605, or some combination thereof.

Pairing external devices, such as neckband 1605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1600 may be provided by a paired device or shared between a paired device and an eyewear device, thus reducing the weight, heat profile, and form factor of the eyewear device overall while still retaining desired functionality. For example, neckband 1605 may allow components that would otherwise be included on an eyewear device to be included in neckband 1605 since users may tolerate a heavier weight load on their shoulders than they would tolerate on their heads. Neckband 1605 may also have a larger surface area over which to diffuse and disperse heat to the ambient environment. Thus, neckband 1605 may allow for greater battery and computation capacity than might otherwise have been possible on a stand-alone eyewear device. Since weight carried in neckband 1605 may be less invasive to a user than weight carried in eyewear device 1602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1605 may be communicatively coupled with eyewear device 1602 and/or to other devices. These other devices may provide certain functions (e.g., tracking, localizing, depth mapping, processing, storage, etc.) to augmented-reality system 1600. In the embodiment of FIG. 16, neckband 1605 may include two acoustic transducers (e.g., 1620(I) and 1620(J)) that are part of the microphone array (or potentially form their own microphone subarray). Neckband 1605 may also include a controller 1625 and a power source 1635.

Acoustic transducers 1620(I) and 1620(J) of neckband 1605 may be configured to detect sound and convert the detected sound into an electronic format (analog or digital). In the embodiment of FIG. 16, acoustic transducers 1620(I) and 1620(J) may be positioned on neckband 1605, thereby increasing the distance between the neckband acoustic transducers 1620(I) and 1620(J) and other acoustic transducers 1620 positioned on eyewear device 1602. In some cases, increasing the distance between acoustic transducers 1620 of the microphone array may improve the accuracy of beamforming performed via the microphone array. For example, if a sound is detected by acoustic transducers 1620(C) and 1620(D) and the distance between acoustic transducers 1620(C) and 1620(D) is greater than, e.g., the distance between acoustic transducers 1620(D) and 1620(E), the determined source location of the detected sound may be more accurate than if the sound had been detected by acoustic transducers 1620(D) and 1620(E).

Controller 1625 of neckband 1605 may process information generated by the sensors on neckband 1605 and/or augmented-reality system 1600. For example, controller 1625 may process information from the microphone array that describes sounds detected by the microphone array. For each detected sound, controller 1625 may perform a direction-of-arrival (DOA) estimation to estimate a direction from which the detected sound arrived at the microphone array. As the microphone array detects sounds, controller 1625 may populate an audio data set with the information. In embodiments in which augmented-reality system 1600 includes an inertial measurement unit, controller 1625 may compute all inertial and spatial calculations from the IMU located on eyewear device 1602. A connector may convey information between augmented-reality system 1600 and neckband 1605 and between augmented-reality system 1600 and controller 1625. The information may be in the form of optical data, electrical data, wireless data, or any other transmittable data form. Moving the processing of information generated by augmented-reality system 1600 to neckband 1605 may reduce weight and heat in eyewear device 1602, making it more comfortable to the user.

Power source 1635 in neckband 1605 may provide power to eyewear device 1602 and/or to neckband 1605. Power source 1635 may include, without limitation, lithium ion batteries, lithium-polymer batteries, primary lithium batteries, alkaline batteries, or any other form of power storage. In some cases, power source 1635 may be a wired power source. Including power source 1635 on neckband 1605 instead of on eyewear device 1602 may help better distribute the weight and heat generated by power source 1635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1700 in FIG. 17, that mostly or completely covers a user's field of view. Virtual-reality system 1700 may include a front rigid body 1702 and a band 1704 shaped to fit around a user's head. Virtual-reality system 1700 may also include output audio transducers 1706(A) and 1706(B). Furthermore, while not shown in FIG. 17, front rigid body 1702 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1600 and/or virtual-reality system 1700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1600 and/or virtual-reality system 1700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1600 and/or virtual-reality system 1700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

### EXAMPLE EMBODIMENTS

Example 1: A display system that includes a BLU having an array of spatially coherent light sources and a beam spot generation module overlapping the array of spatially coherent light sources. The display system also includes a display panel overlapping the BLU. Light from the array of spatially coherent light sources is diffracted by the beam spot generation module to produce an array of beam spots corresponding to an array of pixels in the display panel.

Example 2: The display system of Example 1, where the spatially coherent light sources include VCSELs.

Example 3: The display system of Example 2, where each of the VCSELs includes a polarization selection mechanism placed outside of a cavity of the VCSEL or embedded with the cavity of the VCSEL.

Example 4: The display system of Example 3, where the polarization selection mechanism includes at least one of 1) a polarization dependent absorbing, scattering, diffracting, or reflecting material or structure, 2) a polarization dependent phase retarder, 3) a polarization dependent optical refraction or reflecting element, or 4) an etched structure applying asymmetry to the VCSEL operation.

Example 5: The display system of Example 4, where the optical refraction or reflecting element includes a lens, a curved mirror, a meta-lens or a meta-mirror and the etched structure includes an etched bar or etched grating.

Example 6: The display system of any of Examples 2-5, where the VCSELs are each configured with one set of electrodes in contact with one or more layers above a gain medium of the VCSEL and another set of electrodes in contact with one or more layers below the gain medium to allow injection current to go through the gain medium and generate light.

Example 7: The display system of Example 6, where the one or more layers above the gain medium include at least a portion of at least one of a cladding, a focusing layer, or a multi-stack of partial reflectance/high reflectance layers. The one or more layers below the gain medium include at least a portion of at least one of another cladding layer, an HR layer, or a substrate.

Example 8: The display system of any of Examples 2-7, where wavelength conversion modules overlap at least some of the VCSELs to change wavelengths of light emitted by the overlapped VCSELs.

Example 9: The display system of Example 8, where the wavelength conversion modules include one or more nonlinear materials configured to convert non-visible light, or light of some wavelength/color to visible light of a desired wavelength/color.

Example 10: The display system of any of Examples 8 and 9, where the wavelength conversion modules perform at least one of 1) wavelength conversion processes to convert NIR light to visible light via at least one of second harmonic generation, third harmonic generation, high-order harmonic generation, or four-wave mixing or 2) wavelength conversion processes to convert higher-frequency light into lower-frequency light via at least one of parametric down conversion or four wave mixing.

Example 11: The display system of Example 1, where the array of spatially coherent light sources includes at least one of edge emitting lasers, fiber lasers, heterogeneously integrated lasers, hybrid-lasers, superluminescent diodes, or nonlinear converted light sources.

Example 12: The display system of any of Examples 1-11, where the light from the array of spatially coherent light sources is 1) propagated through a light-guiding medium before being redirected by one or more reflective and/or transmissive optical elements and 2) reshaped by a reflective or transmissive optical element that changes the wavefront of the beam.

Example 13: The display system of any of Examples 1-12, where the light from the array of spatially coherent light sources is propagated through a light-guiding channel before being redirected into vertical direction through an out-coupler.

Example 14: The display system of Example 13, where the out-coupler includes at least one of a waveguide grating coupler, a metasurface, or a holographic diffraction element.

Example 15: The display system of any of Examples 1-14, where the beam spot generation module includes at least one of a metasurface, a diffractive optical element, a holographic optical element, a volume holographic optical element, or a micro-lens array.

Example 16: The display system of any of Examples 1-15, where the beam spot generation module responds to more than one color and generated arrays of beam spots for different colors are spatially different and separated to match a sub-pixel arrangement of the display panel.

Example 17: The display system of any of Examples 1-16, where the beam spot generation module responds to more than one color and generated arrays of beam spots for different colors spatially overlap to match the pixel arrangement of a color sequential display panel.

Example 18: The display system of any of Examples 1-17, where spatially coherent light sources of the array of spatially coherent light sources may be selectively illuminated relative to other spatially coherent light sources of the array of spatially coherent light sources.

Example 19: A BLU that includes 1) an array of spatially coherent light sources, 2) an array of wavelength conversion modules overlapping at least a portion of the array of spatially coherent light sources, and 3) a beam spot generation module overlapping the array of spatially coherent light sources, where light from the array of spatially coherent light sources is diffracted by the beam spot generation module to produce an array of beam spots.

Example 20: A method that includes 1) mounting a plurality of light sources to a first substrate, 2) positioning a beam spot generation module overlapping the plurality of light sources, and 3) positioning a display panel overlapping the beam spot generation module, where light from the array of spatially coherent light sources is diffracted by the beam spot generation module to produce an array of beam spots directed at an array of pixels in the display panel.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of. ” Finally, for ease of use, the terms “including” and “having” (and their derivatives), as used in the specification and/or claims, are interchangeable with and have the same meaning as the word “comprising. ”

### Display System Including High-Efficiency Zonal Dimming Back Light Unit

Lasers have been looked to as light sources for display panels since they may provide higher brightness, higher directionality, and a larger color gamut in comparison to conventional light-emitting diodes (LEDs), mini-LEDs, organic light-emitting diodes (OLEDs), and other light sources. However, the delivery of laser light to the back of the display panels can present challenges. A conventional lightguide may couple light from the side, for example, resulting in challenges in light uniformity, light cone angle control, and polarization maintenance. An augmented-reality (AR) waveguide with a surface relief grating (SRG) or other diffractive optics delivery can present challenges in terms of uniformity and issues of interference between overlapping parts. Additionally, a photonic integrated circuit (PIC) single-mode waveguide-based delivery system may be undesirably expensive and may not have redundancy on a pixel-to-pixel level. It may also be difficult to implement local dimming on such a waveguide-based system. Further, conventional AR waveguides commonly exhibit severe nonuniformity, which may be device and pupil position dependent.

The present disclosure is generally directed to display systems and devices that include compact laser-array and pixelated color-conversion-based BLUs that can provide segmented local dimming (i.e., zonal illumination), high directionality, high polarization, and high throughput. Additionally, in some examples, the described laser-array-based BLUs may provide redundancy such that multiple light sources are available for each pixel. A display engine with dynamic zonal brightness control may beneficially improve display performance and power budget. As described herein, the BLUs may primarily utilize an individually addressable laser array. In various examples, the BLUs may also include a wavelength-conversion module, a beam spot generation module, and/or one or more spacing layers.

Features from any of the embodiments described herein may be used in combination with one another in accordance with the general principles described herein. These and other embodiments, features, and advantages will be more fully understood upon reading the following detailed description in conjunction with the accompanying drawings and claims.

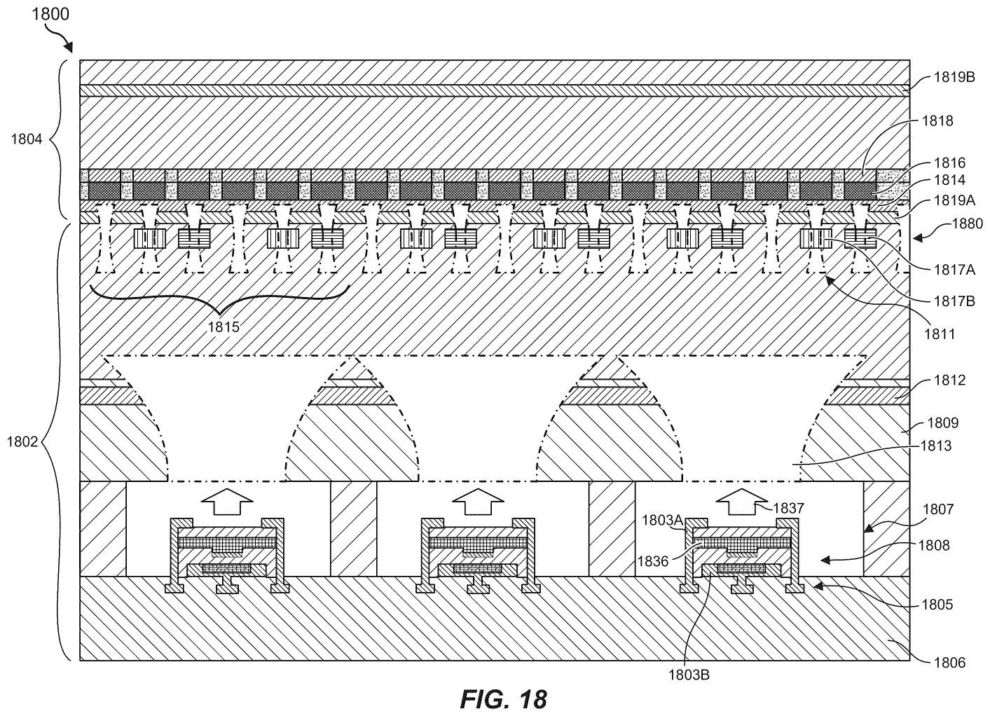

The following will provide, with reference to FIGS. 18-20, a detailed description of display systems and methods of manufacturing and using the same. The discussion associated with FIGS. 18-21 relates to the architecture, operation, and manufacturing of various example display systems and devices. The discussion associated with FIGS. 29 and 30 relates to exemplary virtual reality and augmented reality devices that may include display systems and devices as disclosed herein.

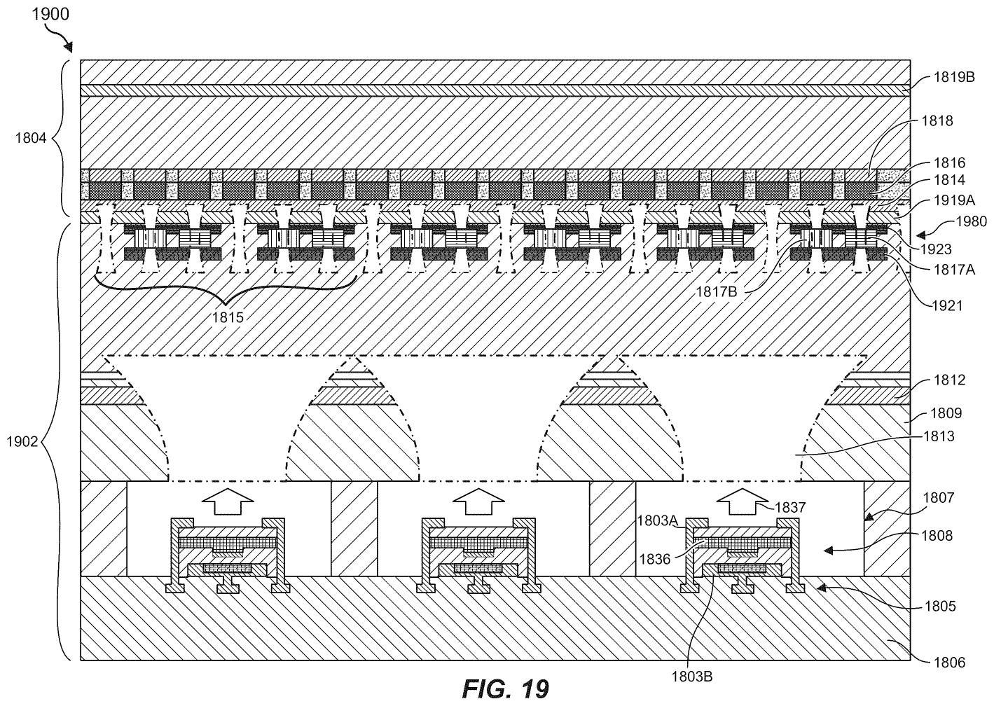

FIGS. 18 and 19 illustrate display systems 1800 and 1900 that each include a display panel overlapping a laser-array and color-conversion-module-based BLU, in accordance with various embodiments. As shown in FIG. 18, a laser-array-based BLU 1802 may include an array of spatially coherent light sources, such as vertical-cavity surface-emitting lasers (VCSELs) 1808, that generate and emit one or multiple wavelengths. While VCSELs 1808 are illustrated in the display systems of FIGS. 18 and 19, BLUs 1802 may additionally or alternatively contain arrays of other suitable laser and/or other light sources, including, for example, laser diodes, fiber lasers, heterogeneously integrated lasers, superluminescent diodes, and/or nonlinearly converted light sources. Nonlinearly converted light sources may include, for example, light beams from pump lasers converted using second harmonic generation (SHG), third harmonic generation (THG), four-wave mixing (FWM), difference frequency generation (DFG), parametric down-conversion (PDC), etc.

VCSELs 1808 and/or other spatially coherent light sources of laser-array-based BLU 1802 may emit one or more colors of light and may be placed in a selected arrangement. In display system 1800 illustrated in FIG. 18, the plurality of VCSELs 1808 may be disposed on a substrate 1806 that includes electronic circuitry for operating VCSELs 1808. VCSELs 1808 may be separated from each other by, for example, light-blocking members or walls extending between adjacent VCSELs 1808. For example, VCSELs 1808 may be disposed in cavities 1807 defined in or on substrate 1806. Display system 1800 may display images having a single color or a plurality of colors (e.g., display system 1800 may be an RGB system that includes red, green, and blue color pixels). In some examples, light beams 1837 from VCSELs 1808 may pass through a beam spot generation module 1812, after which the beams of light for the pixels/sub-pixels may pass through corresponding color conversion modules 1817A/1817B to convert the light beams to one or more colors of light within a selected range(s) of wavelengths. “Pixel,” as used herein, may refer to a single pixel, sub-pixel, group of pixels (e.g., a group of RGB, RGBW, etc. sub-pixels collectively forming a pixel), or other pixel unit.

As shown in FIG. 18, beam spot generation module 1812 may be disposed overlapping the array of VCSELs 1808. Beam spot generation module 1812 may be spaced apart from the array of VCSELs 1808 by a selected distance. For example, a spacer layer 1809 may be disposed between a top of the array of VCSELs 1808 and a bottom of beam spot generation module 1812. Incident light beams 1837 from VCSELs 1808 may be diffracted by beam spot generation module 1812 into a patterned array of beam spots 1811 that are each directed toward and/or focused at a selected plane of an overlapping display panel 1804. In some examples, beam spot groups 1815 may each include a plurality of beam spots 1811 produced by light from a corresponding light beam 1837/VCSEL 1808.

A color conversion layer 1880 may be disposed over beam spot generation module 1812 such that light of each display color may be generated prior to passing through display panel 1804. As illustrated in FIG. 18, color conversion layer 1880 may include a plurality of color conversion modules, such as first and second color conversion modules 1817A and 1817B. In some examples, first and second color conversion modules 1817A and 1817B may each correspond to a separate beam spot from beam spot generation module 1812 and/or a separate pixel/sub-pixel of display panel 1804. For example, first color conversion modules 1817A may convert beam spots 1811 emitted from beam spot generation module 1812 to a first color and second color conversion modules 1817B may convert beam spots 1811 emitted from beam spot generation module 1812 to a second color that is different from the first color.

In at least one example, beam spot generation module 1812 may emit an array of beam spots 1811 that each include a blue wavelength(s) of light corresponding to a blue wavelength(s) of light generated by VCSELs 1808. In this example, first color conversion modules 1817A may convert blue light beam spots 1811 to a green wavelength(s) of light and second color conversion modules 1817B may convert blue light beam spots 1811 to a red wavelength(s) of light. Additionally, blue beam spots 1811 not overlapping first color conversion modules 1817A or second color conversion modules 1817B may pass through color conversion layer 1880 without being converted to another color.

As shown in FIG. 18, display panel 1804 (e.g., an LCD display panel) may be positioned over beam spot generation module 1812 such that light of focused beam spots 1811 from beam spot generation module 1812 efficiently passes through pixel regions of display panel 1804. Beam spots from beam spot generation module 1812 may each cover one or multiple pixel/sub-pixel regions of display panel 1804. As illustrated in FIG. 18, display panel 1804 may include a liquid crystal material 1816 and/or other active material for selectively blocking and/or otherwise modulating light (i.e., beam spots 1815) from beam spot generation module 1812. Display panel 1804 may include an array of pixel electrodes 1818 disposed on one side of liquid crystal material 1816 and one or more a common electrodes 1814 disposed on an opposite side of liquid crystal material 1816. Pixelated light may be emitted from pixel regions of display panel 1804 (i.e., regions corresponding to pixel electrodes 1818). In various examples, display panel 1804 may also include at least one polarizer, such as a polarizer 1819A and/or 1819B overlapping liquid crystal material 1816, pixel electrodes 1818, and common electrode 1814 such that light is polarized prior to passing through display panel 1804 and/or prior to emission from display panel 1804.

FIG. 19 illustrates a display system 1900 that includes a display panel 1804 overlapping a laser-array-based BLU 1902 in accordance with some embodiments. As shown, laser-array-based BLU 1902 may include an array of spatially coherent light sources, such as an array of VCSELs 1808 that emit at least one color of light (e.g., blue and/or UV) and that may be placed in a selected arrangement. In some examples, light emitted by at least some of VCSELs 1808 may be converted to one or more other wavelengths of light. For example, as shown in FIG. 19, light beams 1837 from at least some of the VCSELs 1808 may pass through a beam spot generation module 1812. Display system 1900 may also include a color conversion layer 1980 that includes an array of wavelength conversion modules. For example, color conversion layer 1980 may include first and second color conversion modules 1817A and 1817B, which may convert emitted light beams into one or more colors of light within a selected range(s) of wavelengths.

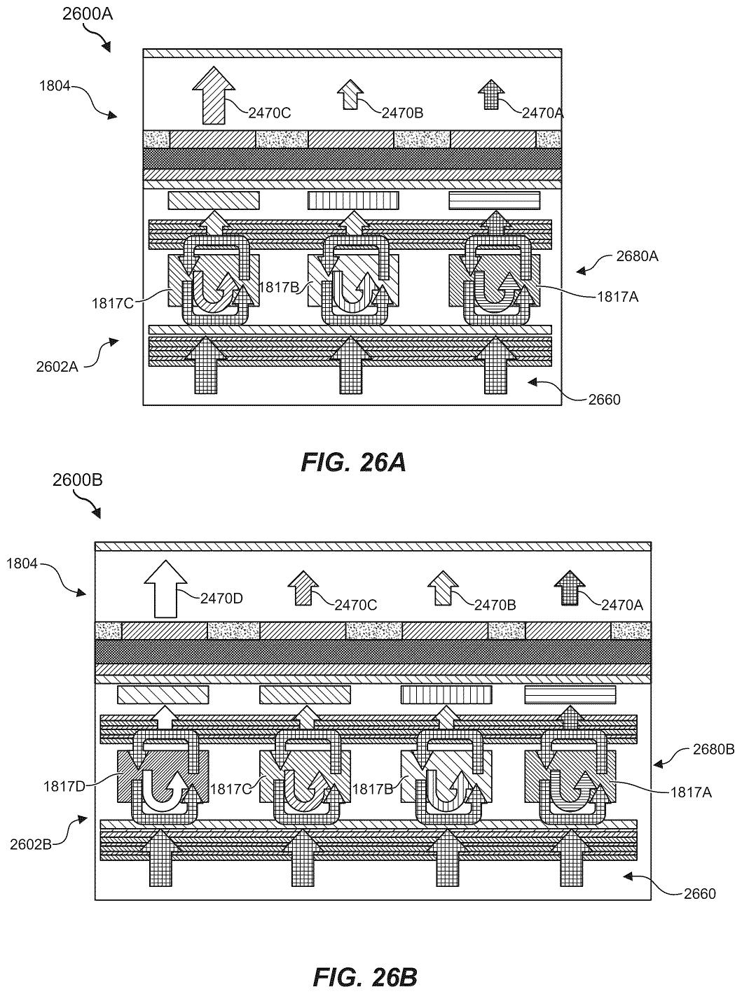

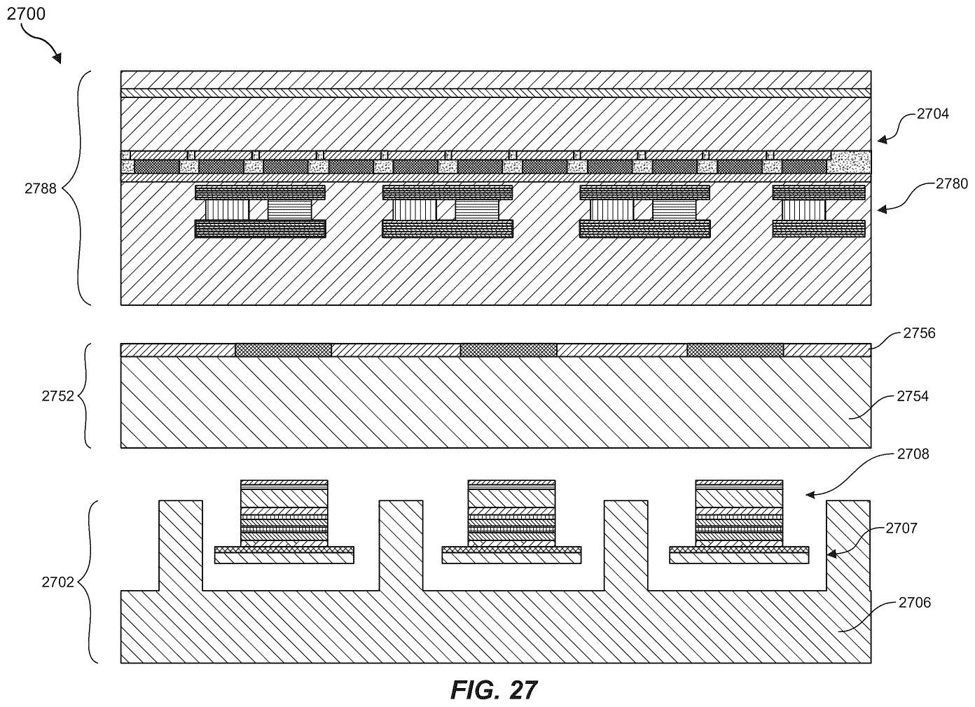

In some embodiments, color conversion layer 1980 may generate a plurality of light colors, such as red, green, and blue light beams, that are directed to corresponding colored pixel/sub-pixel regions of display panel 1804. In at least one embodiment, VCSELs 1808 may each emit blue light beams 1837 (in some examples, light beams 1837 may include UV light). Some of the blue light from light beams 1837 may be transmitted from beam spot generation module 1812 to display panel 1804 without experiencing a wavelength conversion. For example, blue light beam spots overlapping certain blue pixels/sub-pixels of display panel 1804 may pass through color conversion layer 1980 without being channeled through a color conversion module (e.g., first and second color conversion modules 1817A and 1817B). Additional blue light beam spots may pass through first wavelength conversion modules 1817A or second wavelength conversion modules 1817B, which convert the blue light to respective red and green light beam spots directed to corresponding red and green pixel/sub-pixels. In additional examples, at least some of VCSELs 1808 may emit UV light beams. This UV light may pass through red, green, and blue wavelength conversion modules that respectively convert the light to red, green, and blue light beams (see, e.g., FIGS. 26A and 26B).

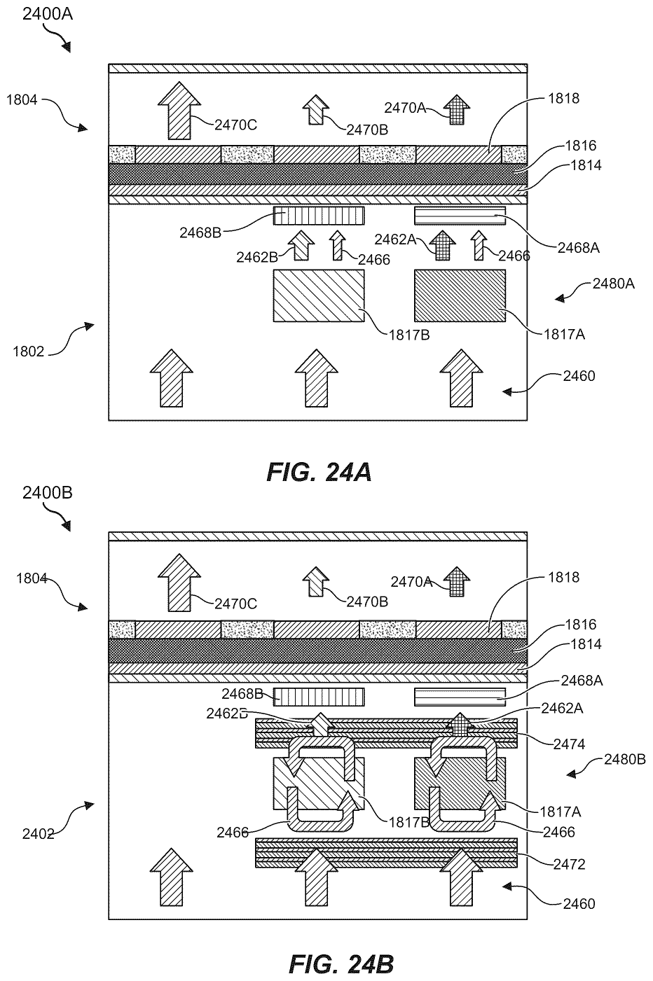

In comparison to display system 1800 shown in FIG. 18, color conversion layer 1880 of display system 1900 shown in FIG. 19 may further include first reflective stacks 1921 and second reflective stacks 1923 respectively positioned below and above first and second color conversion modules 1817A and 1817B. First and second reflective stacks 1921 and 1923 may have varying levels of reflectance with respect to different wavelengths of light. For example, first reflective stack 1921 may have partial reflectance (PR) with respect blue light and high reflectance (HR) with respect to red and/or green light. Additionally, second reflective stack 1923 may have high reflectance with respect to blue light and partial or no reflectance with respect to red and/or green light. Functionalities of such reflective stacks are discussed in greater detail below in reference to FIGS. 24A-26B. As shown in FIG. 19, blue pixel/sub-pixel regions of color conversion layer 1980 may not include first reflective stacks 1921 or second reflective stacks 1923, allowing blue light to pass through these regions without being reflected between reflective stacks.

As shown in FIG. 19, display panel 1804 may include a liquid crystal material 1816 and/or other active material for selectively blocking and/or otherwise modulating light from beam spot generation module 1812 and color conversion layer 1980. Pixelated light, including red, green, and blue pixelated light, may be emitted from pixel/sub-pixel regions of display panel 1804. In various examples, display panel 1804 may also include a polarizer 1819 to polarize the pixelated light prior to emission from display panel 1804.

According to some embodiments, a polarization selection mechanism (e.g., a polarizer) may be placed outside of a VCSEL 1808. Additionally or alternatively, a polarization selection mechanism (e.g., a polarizer) can be built within a VCSEL cavity (see, e.g., cavity 1807 shown in FIGS. 18 and 19). Such a polarization mechanism may, for example, include 1) a polarization dependent absorbing, scattering, and/or reflecting material or structure, 2) a polarization dependent phase retarder, 3) a polarization dependent optical refraction or reflecting element (e.g., a lens, curved mirror, meta-lens, or meta-mirror), and/or 4) an etched structure that applies asymmetry to the VCSEL operation, such as an etched bar or etched grating.

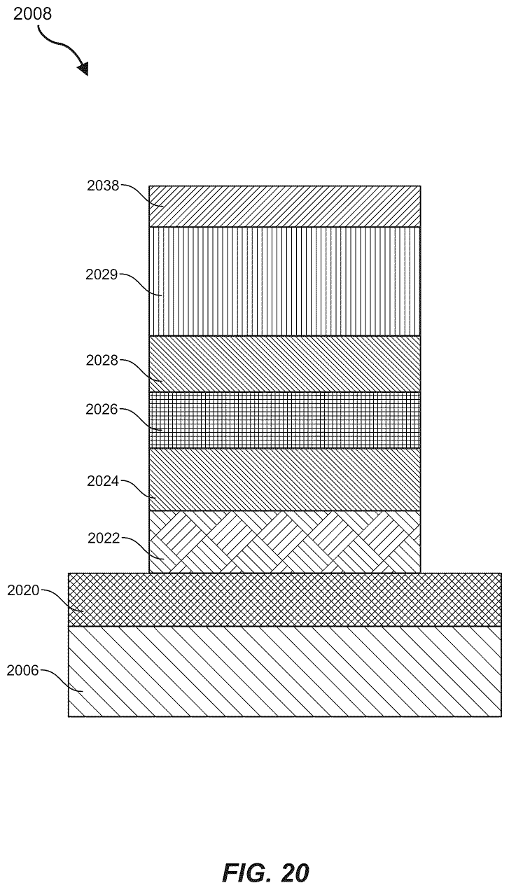

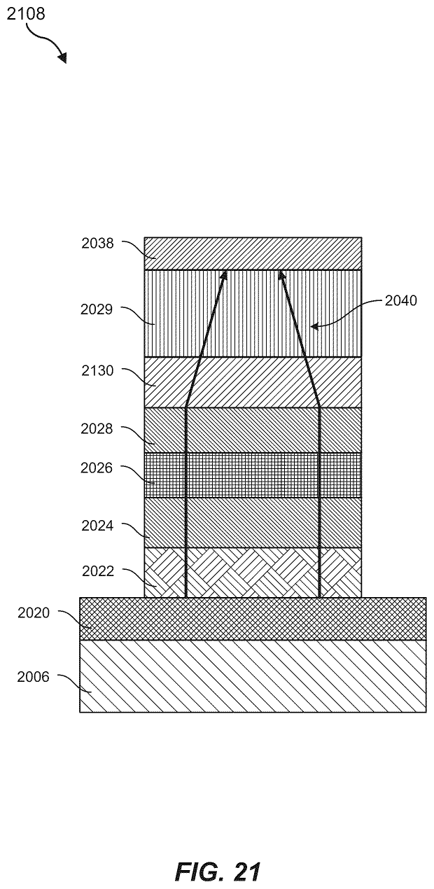

In various examples, an array of VCSELs 1808 may have driving circuitry 1805 directly integrated on and/or within substrate 1806, as shown in FIGS. 18 and 19. In some examples, VCSELs 1808 may each be configured with a first set of electrodes 1803A in contact with one or more layers above a gain medium 1836 and a second set of electrodes 1803B in contact with one or more layers below gain medium 1836 of the VCSEL 1808 to allow injection current to go through gain medium 1836 and generate light. First and second sets of electrodes 1803A and 1803B may each include one or more electrodes. The one or more layers above gain medium 1836 may include at least a portion of a cladding layer, a focusing layer, and/or a multi-stack partial reflectance/high reflectance layer (see, e.g., FIGS. 20-21). The one or more layers below gain medium 1836 may include at least a portion of another cladding, an HR layer, and/or a substrate (see, e.g., FIGS. 20-21).

VCSELs 1808 may be integrated with or transferred onto substrate 1806, which may be formed of one or more materials that can embed power, drive, and/or control circuits for VCSELs 1808. Substrate 1806 may include, for example, silicon (Si), gallium arsenide (GaAs), germanium (Ge), aluminum oxide (Al₂O₃), aluminum nitride (AlN), silicon carbide (SiC), and/or any other suitable semiconductor and/or other materials. In some examples, driving circuitry 1805 within or on substrate 1806 may additionally or alternatively impart other suitable functionality, such as providing electrical, thermal, and/or mechanical interface(s) for internal and/or external components.

A VCSEL 1808, as described herein, may include a VCSEL-based laser cavity that can generate a specified wavelength or range of wavelengths of light. For example, a VCSEL laser cavity may generate near-infrared (NIR), visible (e.g., blue), and/or UV light. In various examples, VCSELs 1808 may contain polarization selective elements, such as etched structures, polarization dependent absorption elements, etc.

FIGS. 20 and 21 illustrate various VCSEL configurations that may be utilized in display systems 1800 and 1900 in accordance with some embodiments. In various examples, VCSELs may be configured with one set of electric conducting layers in contact with one or more layers above a gain medium layer 2026 and another set of electric conducting layers in contact with one or more layers below gain medium layer 2026 to allow injection current to go through the gain medium and generate light.

FIG. 20 shows a VCSEL assembly 2008, in accordance with some embodiments. As shown in FIG. 20, layers above gain medium layer 2026 may include, for example, an upper cladding layer 2028, a PR/HR film stack 2029 that includes one or more partial-reflectance (PR), anti-reflectance (AR), and/or high-reflectance (HR) layers, and in some examples, a visible beam shaper 2038 disposed above gain medium layer 2026 on an upper region of VCSEL 2008 (e.g., above PR/HR film stack 2029). Layers below gain medium layer 2026 may include a lower cladding layer 2024 and one or more HR layers, such as a reflective film stack that includes a first HR layer 2020 and a second HR layer 2022 disposed on a substrate 2006.

FIG. 21 shows a VCSEL assembly 2108, in accordance with various embodiments. As shown in FIG. 20, layers above gain medium layer 2026 may include, for example, an upper cladding layer 2028, a PR/HR film stack 2029, and in some examples, a visible beam shaper 2038 disposed above gain medium layer 2026 on an upper region of VCSEL 2108 (e.g., above PR/HR film stack 2029). Additionally, a focusing layer 2130 may be included above gain medium 2026. Layers below gain medium layer 2026 may include a lower cladding layer 2024 and one or more HR layers, such as a reflective film stack that includes a first HR layer 2020 and a second HR layer 2022 disposed on a substrate 2006. In some examples, an additional focusing layer may be disposed below gain medium 2026. One or more of the layers in the illustrated VCSEL designs, including VCSEL assemblies 2008 and 2108, may exhibit polarization dependence.

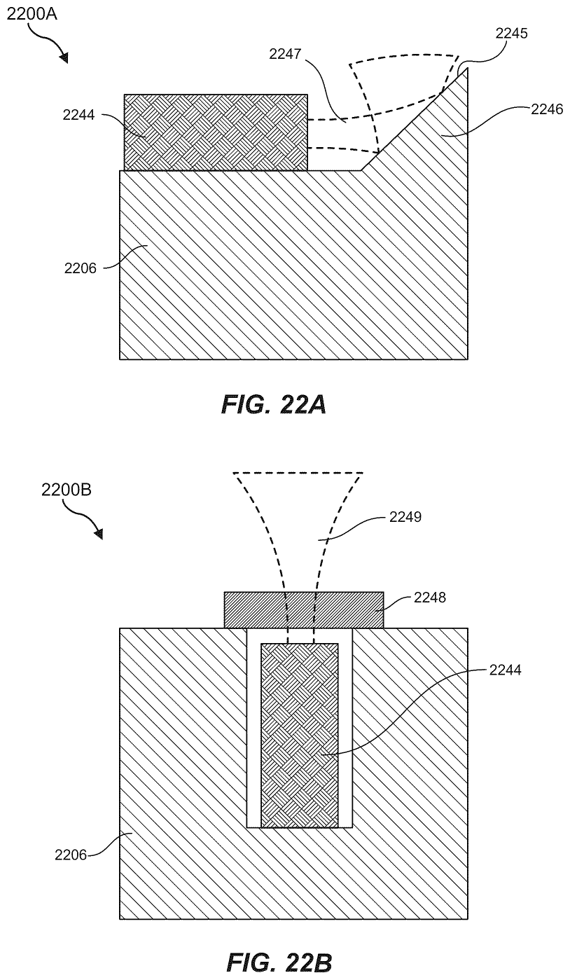

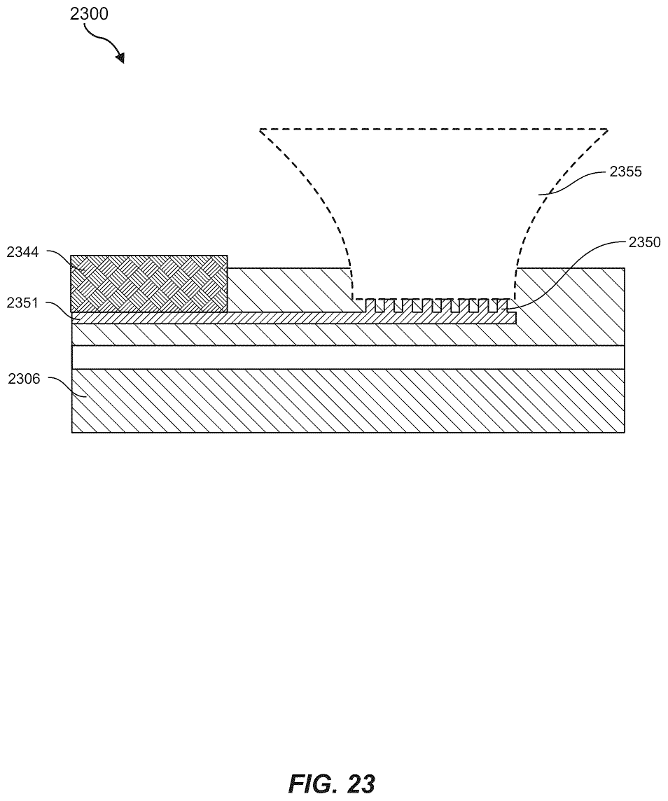

FIGS. 22A-23 illustrate various examples of light sources and beam distribution components that may be utilized in BLUs of display systems, such as those disclosed herein. In some embodiments, a beam reshaping element may be a reflective or transmissive type, or the beam reshaping element may combine both reflective and transmissive elements. Additional phase front modulation features may also be included so that each emitted beam can achieve a selected spatial profile when it reaches a beam spot array generation module (see, e.g., beam spot generation module 1812 in FIGS. 18 and 19).

In one example, a portion of a laser-array-based BLU 2200A, as shown in FIG. 22A, may include at least one light source 2244 (e.g., a laser source) that emits a beam of light 2247 in a direction that is parallel or substantially parallel to a planar surface of a substrate 2206. Light 2247 emitted by light source 2244 may be reflected toward a beam spot generation module (e.g., beam spot generation module 1812 in FIGS. 18 and 19) by a beam-reshaping reflective element 2246 having a reflective surface 2245 that is sloped at a selected angle with respect to substrate 2206. Beam-reshaping reflective element 2246 may spread the beam of light 2247 to widen the coverage area of light from the beam.

FIG. 22B shows a portion of a laser-array-based BLU 2200B that includes at least one light source 2244 (e.g., a laser source) disposed in a cavity defined in a substrate 2206. As shown, a beam of light 2249 emitted by light source 2244 may pass through a transmissive beam-reshaping element 2248, which may spread the beam of light 2249 to widen a coverage region of light from the beam. Reflective and/or transmissive type beam-reshaping elements, such as those shown in FIGS. 22A and 22B, may add additional phase front modulation so the emitted beams can reach a desired spatial profile when they reach a beam spot array generation module (e.g., beam spot generation module 1812 in FIGS. 18 and 19).

According to at least one embodiment, a light source may be placed in the vicinity of one or more BLU zones. FIG. 23 shows, for example, a portion of a laser-array-based BLU 2300 that includes at least one light source 2344 (e.g., a laser source) disposed on a substrate 2306. In the example shown in FIG. 23, light emitted by the light source 2344 may be coupled into a waveguide 2351 or other type of light guide. The light may propagate through waveguide 2351 to an out-coupler 2350, which then emits light 2355 vertically or substantially vertically relative to substrate 2306. As illustrated in FIG. 23, out-coupler 2350 may emit an expanded region of light 2355 from various exit regions of out-coupler 2350.

According to various embodiments, a beam spot generation module (see, e.g., beam spot generation module 1812 in FIGS. 18 and 19) may take an output beam profile (e.g., an approximately Gaussian-like profile, etc.) from one or more light sources (e.g., VCSELs 1808/2008A/2008B/2108A/2108B in FIGS. 18-21) after a certain propagation distance (e.g., from approximately 10 μm to approximately 1 mm). In at least one example, the beam spot generation module may generate a specific array of uniform or quasi-uniform spots that match a pixel/sub-pixel arrangement pattern (e.g., RGB stripe, RGBG, RGBW, pentile RGBG) of an LCD display (e.g., display panel 1804 in FIGS. 18 and 19) at a given distance (e.g., approximately 50 μm to to approximately 1 mm). The pattern of uniform/quasi-uniform spots may propagate through the display panel to produce a pixel-based image.

In some embodiments, the respective beam spot arrays for different colors can be spatially different and may be separated to match sub-pixel arrangements (e.g., RGB stripe, RGBG, RGBW, pentile RGBG) of the display panel. A center location of the spot arrays for different colors can also be identical and may spatially overlap to meet pixel arrangements of color-multiplexing-based display panels. In at least one embodiment, portions of a beam spot generation module in front of different VCSELs within a segment may be designed differently so as to generate spatially-overlapping beam spot arrays at a desired plane. Such spatially-overlapping beam spot arrays may provide lighting redundancy, enabling light to be provided to each pixel/sub-pixel, even when one or more of the VCSELs are non-operational. A beam spot generation module (see, e.g., beam spot generation module 1812 in FIGS. 18 and 19), as described herein, may include one or more of 1) a meta-surface, 2) a diffractive optical element, 3) a holographic optical element, 4) a volume holographic optical element, and/or 5) a micro-lens array.

FIGS. 24A-26B illustrate various exemplary color conversion modules, according to various embodiments. Color conversion modules may contain one or a combination of color-conversion materials that can absorb light within a certain wavelength range and emit light in a desired wavelength range. Such color-conversion materials may include, for example, a quantum dot material, a fluorescent material, a quantum well material, a semiconductor nanowire material, and/or any other suitable color-converting materials.

In some embodiments, each of the color conversion modules may also contain one or more of the following: (1) high/partial reflective (HR/PR) film stacks to form a resonant cavity for the pump light (e.g., blue, UV, etc.) to enhance absorption, and consequently, conversion efficiency, (2) HR/PR film stacks to form a resonant cavity for the converted light to better control its spectral and angular profile, and (3) polarizers (e.g., wire-grid, particle, multi-stack, reflective polarizer, etc.). In at least one example, a reflective polarizer may be utilized with a waveplate and reflective coatings to recycle color-converted light in an unwanted polarization state to improve overall light extraction efficiency.

FIG. 24A shows an exemplary display system 2400A having a laser-array-and color-conversion-module-based BLU with a single pass color conversion configuration, according to some embodiments. As shown, initial light beams 2460, such as beam spots (e.g., from a beam spot generation module 1812 as shown in FIGS. 18 and 19), may pass through a color conversion layer 2480A of laser-array-based BLU 1802. Initial light beams 2460 may be any suitable color such as a visible blue color or other suitable visible or nonvisible color (e.g., UV, NIR, etc.). In the example shown, initial light beams 2460 may include a blue wavelength(s) light. At least some pixels/subpixels of display panel 1804 may not be overlapped by color conversion modules such that blue light beams 2460 pass through color conversion layer 2480A without experiencing changes in wavelengths. Accordingly, light from such pixel regions may be pass through display panel 1804 and be emitted as pixelated blue light 2470C.

Additional regions of color conversion layer 2480A may include first and second color conversion modules 1817A and 1817B. According to at least one example, first color conversion module 1817A may convert blue light of an initial light beam 2460 to green light 2462A. As shown in FIG. 24A, at least some amount of blue light 2466 from the initial light beam 2460 may pass through first color conversion module 1817A without being converted. A first filter 2468A (e.g., a green color filter) may thus overlap first color conversion module 1817A to remove the residual blue light 2466 such that a beam of primarily green light is directed through display panel 1804 and emitted as pixelated green light 2470A. Additionally, second color conversion module 1817B may convert blue light of an initial light beam 2460 to red light 2462B. As shown in FIG. 24A, at least some amount of blue light 2466 from the initial light beam 2460 may also pass through second color conversion module 1817B without being converted. A second filter 2468B (e.g., a red color filter) may thus overlap second color conversion module 1817B so that a beam of primarily red light is directed through display panel 1804 and emitted as pixelated red light 2470B.

FIG. 24B shows an exemplary display system 2400B having a laser-array-and color-conversion-module-based BLU with layered HR/PR stacks for enhanced conversion efficiency of blue light to various colors, including red and green colors, according to some embodiments. As shown, initial light beams 2460 may pass through a color conversion layer 2480B of a laser-array-based BLU 2402. Initial light beams 2460 may be any suitable visible or nonvisible color, and in the example shown, initial light beams 2460 may include a blue wavelength(s) light. At least some pixels/subpixels of display panel 1804 may not be overlapped by color conversion modules such that blue light beams 2460 pass through color conversion layer 2480B and are emitted as pixelated blue light 2470C.

Additional regions of color conversion layer 2480B may include first and second color conversion modules 1817A and 1817B. For example, a first color conversion module 1817A may convert blue light of an initial light beam 2460 to green light 2462A and a second color conversion module 1817B may convert blue light of an initial light beam 2460 to red light 2462B. A first filter 2468A and a second filter 2468B may respectively overlap first color conversion module 1817A and second color conversion module 1817B to filter out any residual blue light passing through these modules.

As shown in FIG. 24B, color conversion layer 2480B may further include a first reflective film stack 2472 and a second reflective film stack 2474 overlapping first and second color conversion modules 1817A and 1817B. In at least one embodiment, first reflective film stack 2472 may be disposed on a first side of first and second color conversion modules 1817A and 1817B (e.g., on a side facing light sources, such as VCSELs 1808 in FIGS. 18 and 19) and second reflective film stack 2474 may be disposed on a second side of first and second color conversion modules 1817A and 1817B (e.g., a side facing display panel 1804). First and second reflective film stacks 2472 and 2474 may together form a resonant cavity that includes the overlapped first and second color conversion modules 1817A and 1817B.

In this example, first and second reflective film stacks 2472 and 2474 may selectively reflect blue light within the resonant cavity to enhance conversion efficiency of blue light into green and/or red light. For example, first reflective film stack 2472 may be partially reflective with respect to blue light, enabling a significant proportion of blue light from initial light beams 2460 to enter into the resonant cavity. Second reflective film stack 2474 may be highly reflective with respect to blue light. Accordingly, substantially all blue light light passing unconverted through first and second color conversion modules 1817A and 1817B may be reflected back towards first and second color conversion modules 1817A and 1817B and first reflective film stack 2472. Subsequently, first reflective film stack 2472 may reflect a significant proportion of the recycled blue light back again through first and second color conversion modules 1817A and 1817B, where additional blue light is converted to green and red light. As such, additional blue light may be recycled and converted to green and red light within first and second color conversion modules 1817B. Green light 2462A and red light 2462B exiting second reflective film stack 2474 may then respectively pass through first filter 2468A and second filter 2468B to remove any residual blue light prior to passing through display panel 1804.

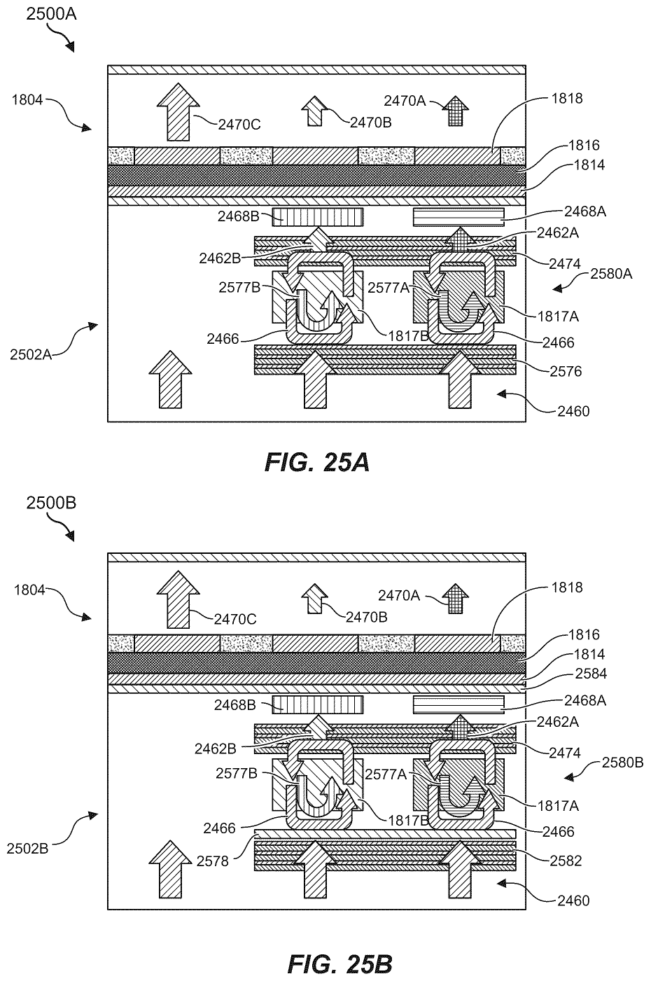

FIG. 25A shows an exemplary display system 2500A having a laser-array-and color-conversion-module-based BLU with HR/PR stacks that include red and green light reflectors for enhancing light extraction efficiency, according to some embodiments. As shown, initial light beams 2460 may pass through a color conversion layer 2580A of a laser-array-based BLU 2502A. Initial light beams 2460 may be any suitable visible or nonvisible color, and in the example shown, initial light beams 2460 may include a blue wavelength(s) light. At least some pixels/subpixels of display panel 1804 may not be overlapped by color conversion modules such that blue light beams 2460 pass through color conversion layer 2580A and are emitted as pixelated blue light 2470C. Additional regions of color conversion layer 2580A may include first and second color conversion modules 1817A and 1817B that respectively convert blue light of initial light beams 2460 to green light 2462A and red light 2462B. A first filter 2468A and a second filter 2468B may respectively overlap first color conversion module 1817A and second color conversion module 1817B to filter out any residual blue light passing through these modules.

As shown in FIG. 25A, color conversion layer 2580A may include a first reflective film stack 2576 and a second reflective film stack 2474 forming a resonant cavity including first and second color conversion modules 1817A and 1817B. In at least one embodiment, first reflective film stack 2576 may be disposed on a first side of first and second color conversion modules 1817A and 1817B (e.g., on a side facing light sources, such as VCSELs 1808 in FIGS. 18 and 19) and second reflective film stack 2474 may be disposed on a second side of first and second color conversion modules 1817A and 1817B (e.g., a side facing display panel 1804). In this example, first and second reflective film stacks 2576 and 2474 may selectively reflect blue light within the resonant cavity to enhance conversion efficiency of blue light into green and/or red light. For example, first reflective film stack 2576 may be partially reflective with respect to blue light and second reflective film stack 2474 may be highly reflective with respect to blue light, as described above in reference to FIG. 24B. Accordingly, first and second reflective film stacks 2576 and 2474 may enhance conversion efficiency of blue light to red and green light colors within first and second color conversion modules 1817A and 1817B.

In at least one embodiment, one or more layers that are highly reflective with respect to red and/or green colored light may also be included within first reflective film stack 2576. Accordingly, as illustrated in FIG. 25A, first reflective film stack 2576 may reflect stray green light 2577A and stray red light 2577B (i.e., green and red light converted by first and second color conversion modules 1817A and 1817B and directed away from display panel 1804). Accordingly, rather than being lost, the stray green and red light 2577A and 2577B may be effectively recycled by first reflective film stack 2576, which reflects the green and red light back towards display panel 1804. Green light 2462A and red light 2462B exiting second reflective film stack 2474 may then respectively pass through first filter 2468A and second filter 2468B to remove any residual blue light prior to passing through display panel 1804.

FIG. 25B shows an exemplary display system 2500B having a laser-array-and color-conversion-module-based BLU with an upper reflective polarizer and lower quarter-wave plate (QWP) for polarization recycling of light, according to some embodiments. As shown, initial light beams 2460 may pass through a color conversion layer 2580B of a laser-array-based BLU 2502B. Initial light beams 2460 may be any suitable visible or nonvisible color, and in the example shown, initial light beams 2460 may include a blue wavelength(s) light. At least some pixels/subpixels of display panel 1804 may not be overlapped by color conversion modules such that blue light beams 2460 pass through color conversion layer 2580B and are emitted as pixelated blue light 2470C. Additional regions of color conversion layer 2580B may include first and second color conversion modules 1817A and 1817B that respectively convert blue light of initial light beams 2460 to green light 2462A and red light 2462B. A first filter 2468A and a second filter 2468B may respectively overlap first color conversion module 1817A and second color conversion module 1817B to filter out any residual blue light passing through these modules.

As shown in FIG. 25B, color conversion layer 2580B may include a first reflective film stack 2582 and a second reflective film stack 2474 forming a resonant cavity including first and second color conversion modules 1817A and 1817B to enhance conversion efficiency of blue light into green and/or red light. Additionally, one or more layers that are highly reflective with respect to red and/or green colored light may also be included within first reflective film stack 2582 to reflect and recycle stray green light 2577A and stray red light 2577B.

According to some examples, a quarter wave plate (QWP) 2578 may also be disposed on or within first reflective film stack 2582. Additionally, a reflective polarizer 2584 may be disposed on or within a suitable location of laser-array-based BLU 2502B. For example, reflective polarizer 2584 may be positioned between second reflective film stack 2474 and display panel 1804. In the illustrated example, reflective polarizer 2584 is disposed between display panel 1804 and first and second filters 2468A and 2468B. Reflective polarizer 2584 may be utilized to allow only passage of green and red light having a selected polarization, blocking and reflecting other light back through color conversion layer 2580B. QWP 2578 may be used in conjunction with reflective polarizer 2584 to recycle and change the polarization state of light that is reflected back toward QWP 2578 by reflective polarizer 2584. More particularly, the polarization state of light passing through QWP 2578 may be changed by QWP 2578. In some examples, light reflected by reflective polarizer 2584 may pass through QWP 2578 to first reflective film stack 2582, where a substantial portion of the light is again reflected back through QWP 2578 and color conversion layer 2580B toward reflective polarizer 2584. A substantial portion of recycled green and red light 2577A and 2577B may be in a proper polarization state to pass through reflective polarizer 2584, having passed QWP 2578 at least twice. Thus, the light extraction efficiency of polarized green and red light may be enhanced.

FIG. 26A shows an exemplary display system 2600A having a laser-array-and color-conversion-module-based BLU in which UV light is converted to red, green, and blue colors for corresponding pixels, according to some embodiments. As shown, initial light beams 2660 may pass through a color conversion layer 2680A of a laser-array-based BLU 2602A. Initial light beams 2660 may be any suitable visible or nonvisible color, and in the example shown, initial light beams 2660 may include a UV wavelength(s) light. Regions of color conversion layer 2680A may include first, second, and third color conversion modules 1817A, 1817B, and 1817C. According to at least one example, first color conversion module 1817A may convert UV light of an initial light beam 2460 to green light, second color conversion module 1817B may convert UV light to red light, and third color conversion module 1817C may convert UV light to blue light.

One or more of the features described above in reference to FIGS. 24A-8B may be included in laser-array-based BLU 2602A to enhance conversion efficiency of UV light to one or more light colors, to enhance extraction efficiency of one or more light colors, and/or to facilitate polarization. For example, laser-array-based BLU 2602A may include one or more reflective film stacks, reflective polarizers, QWPs, and/or any other suitable features. Additionally, red, green, and blue filters may be disposed over corresponding color conversion modules to filter out residual amounts of UV and/or other wavelengths of light. Light from laser-array-based BLU 2602A may pass through display panel 1804, which emits pixelated green light 2470A, red light 2470B, and blue light 2470C from pixel/sub-pixel regions corresponding to first, second, and third color conversion modules 1817A, 1817B, and 1817C.

FIG. 26B shows an exemplary display system 2600B having a laser-array-and color-conversion-module-based BLU in which UV light is converted to red, green, blue, and white colors for corresponding pixels, according to some embodiments. As shown, a laser-array-based BLU 2602B may include a color conversion layer 2680B with first, second, and third color conversion modules 1817A, 1817B, and 1817C for converting initial light beams 2660 (e.g., UV light beams) to visible light (e.g., green, red, and blue light). Additionally, color conversion layer 2680B may further include fourth color conversion modules 1817D that convert initial light beams 2660 to broadband light (e.g., white light) in corresponding pixel/sub-pixel regions. The broadband light may include a fairly broad range of visible light wavelengths and/or a combination of multiple colors of different wavelengths. Broadband light emitted from a fourth color conversion module 1817D may pass through display panel 1804 and be emitted as pixelated white light 2470D, as shown in FIG. 26B. One or more of the features described above in reference to FIGS. 24A-8B may be included in laser-array-based BLU 2602B to enhance conversion efficiency of UV light to one or more light colors, to enhance extraction efficiency of one or more light colors, and/or to facilitate polarization.

FIG. 27 shows an exemplary assembly 2700 for a display system (e.g., display system 1800/200/2400A/2400B/2500A/2500B/2600A/2600B shown in FIGS. 18, 19, and 24A-26B), according to some embodiments. A display system, as disclosed herein, may be assembled in any suitable manner. For example, VCSELs 2708 may first be fabricated prior to coupling VCSELs 2708 to a first substrate 2706. In some examples, WL conversion modules may be co-fabricated with other elements/layers of VCSELs 2708 (e.g., color-converted VCSELs) depending on the specific stack design (see, e.g., FIGS. 20-21). First substrate 2706 for mounting VCSELs 2708 may be fabricated with driving circuits (see, e.g., circuitry 1805 in FIGS. 18 and 19) as well as mechanical stops for VCSELs 2708. VCSELs 2708 may be picked and selectively placed onto first substrate 2706 in any suitable manner (e.g., via integrated circuit mounting, thermal attachment, etc.) to form an array of VCSELs 2708 for assembly 2700. In some examples, VCSELs 2708, or at least a portion thereof, may be disposed within corresponding cavities 2707.

A beam spot generation portion 2752 may be formed separately from VCSEL portion 2702 of assembly 2700. To manufacture beam spot generation portion 2752, diffractive optical elements (DOEs) and/or holographic optical elements (HOEs 2756) may be fabricated as a DOE/HOE layer 2756 on a second substrate 2754 that is separate from VCSEL portion 2702. DOE/HOE layer 2756 may act as a beam spot generation module (see, e.g., beam spot generation module 1812 in FIGS. 18 and 19) that is used to direct light from VCSELs 2708 to display panel 2704 overlapping beam spot generation portion 2752 and VCSEL portion 2702.

Beam spot generation portion 2752, which includes second substrate 2754 combined with DOE/HOE layer 2756, may be laminated onto VCSEL portion 2702, which includes VCSELs 2708 mounted on first substrate 2706. In some examples, VCSELs 2708 may be combined with first substrate 2706 to form VCSEL portion 2702 and DOE/HOE layer 2756 may be separately combined with second substrate 2754 to form beam spot generation portion 2752. Beam spot generation portion 2752 may then be laminated onto VCSEL portion 2702 with, for example, passive alignment to produce a laser-array-based BLU (see, e.g., laser-array-based BLUs 1802/202 in FIGS. 18 and 19).

According to at least one embodiment, a pixel-forming portion 2788, which includes a color conversion layer 2780 and an overlapping display panel 2704, may be fabricated separate from the beam spot generation potion 2752 and VCSEL portion 2702. In some examples, display panel 2704 may be co-fabricated with color conversion layer 2780 (see, e.g., FIGS. 18, 19, and 24A-26B) to form pixel-forming portion 2788, which may then be laminated onto the top surface of beam spot generation portion 2752 with passive or active alignment. Active alignment in this example may refer to turning on one or more VCSELs during alignment.

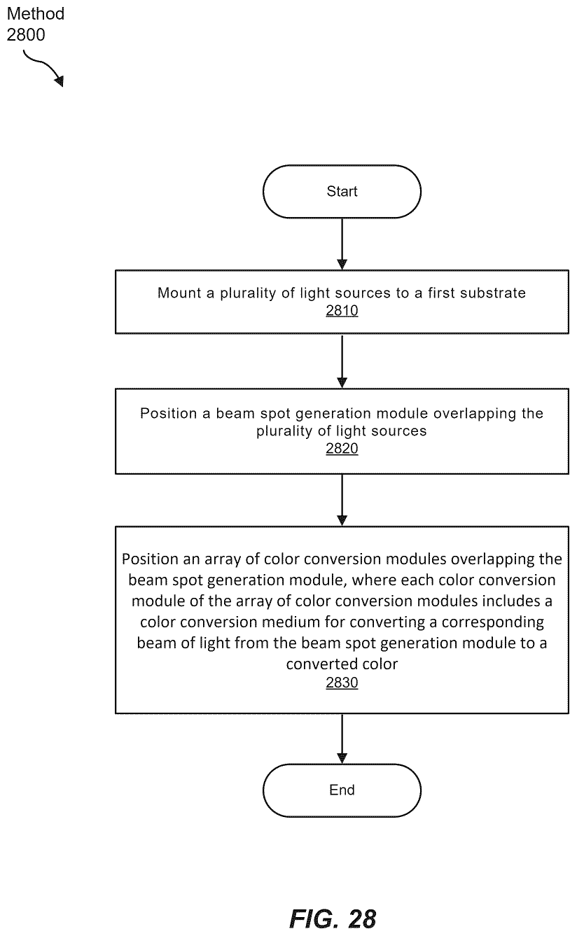

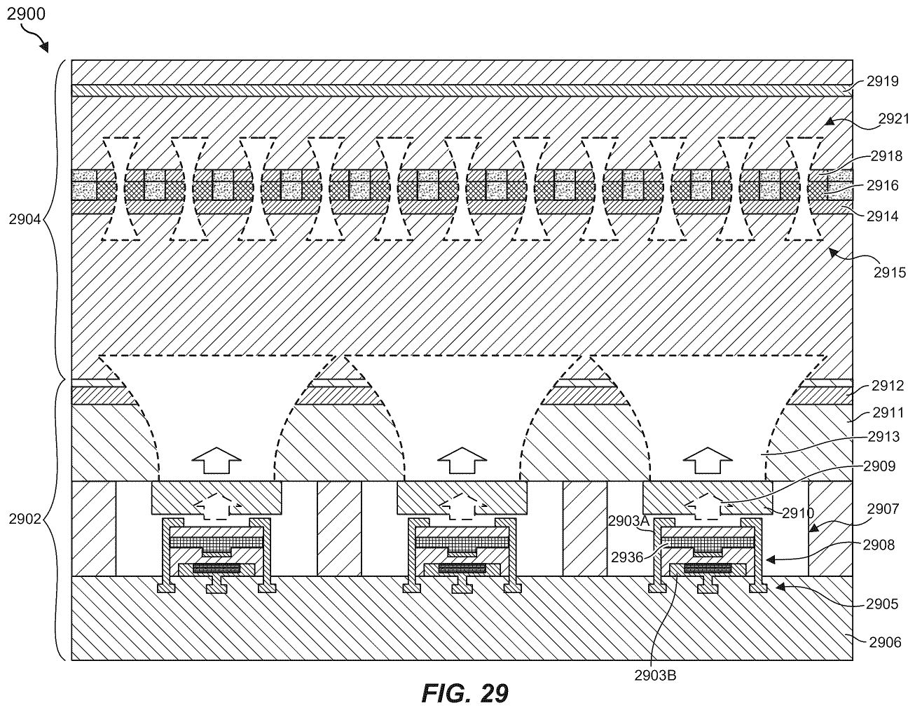

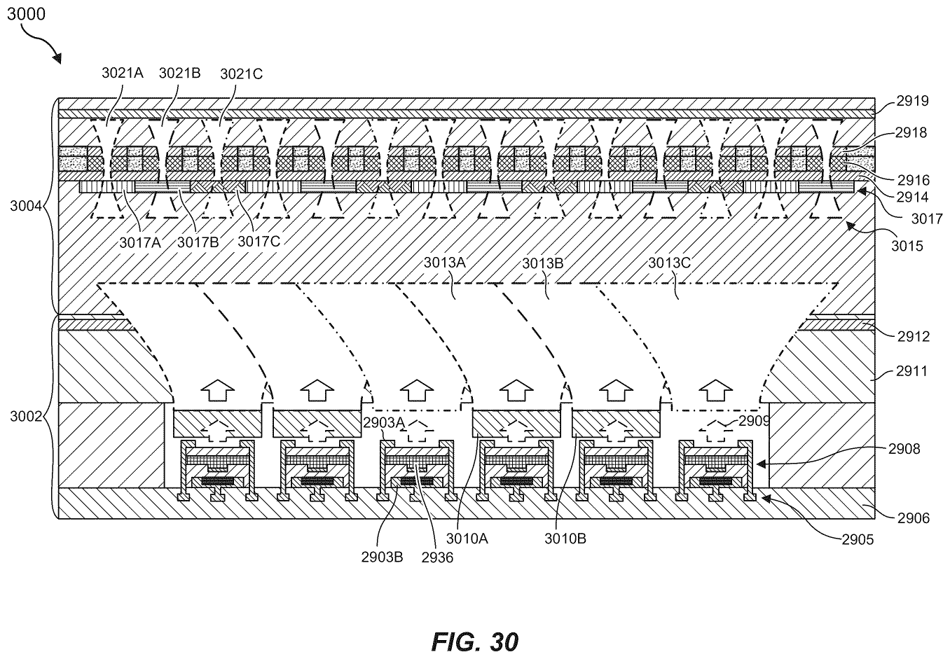

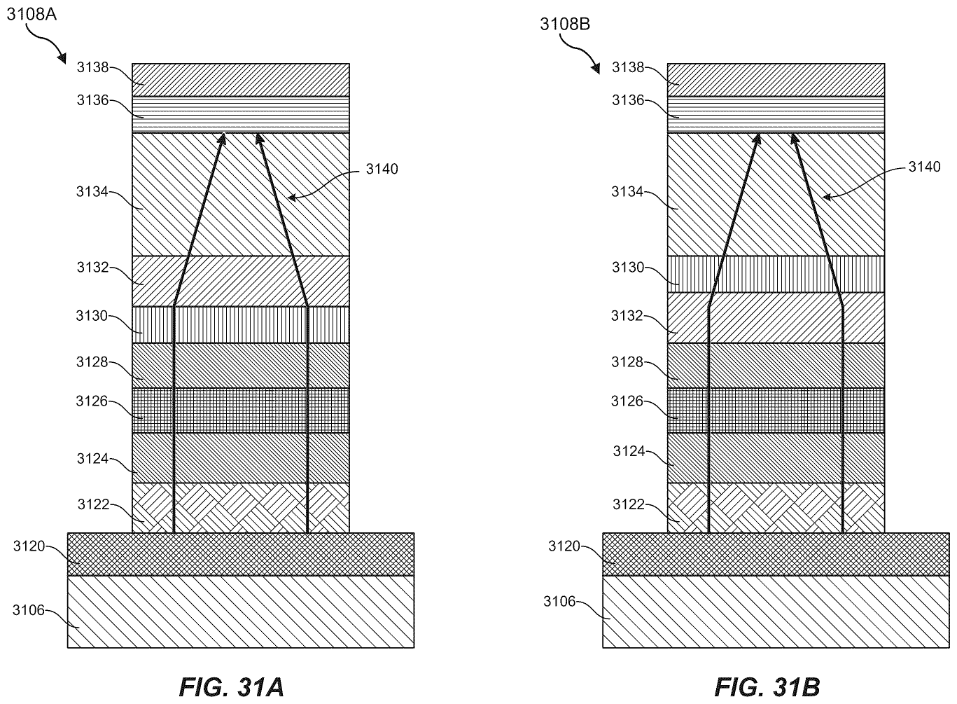

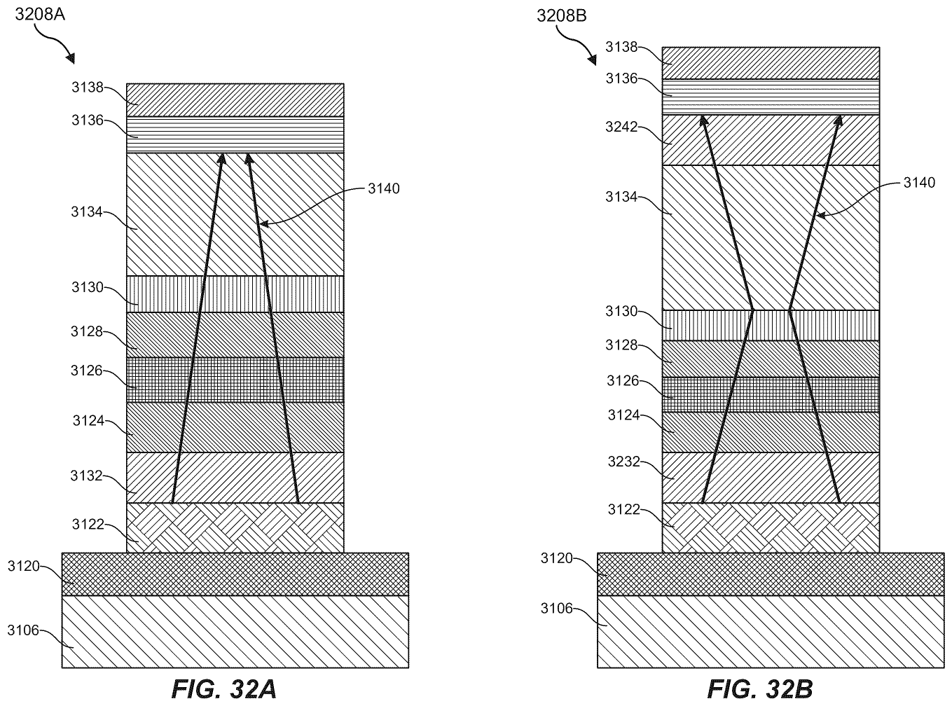

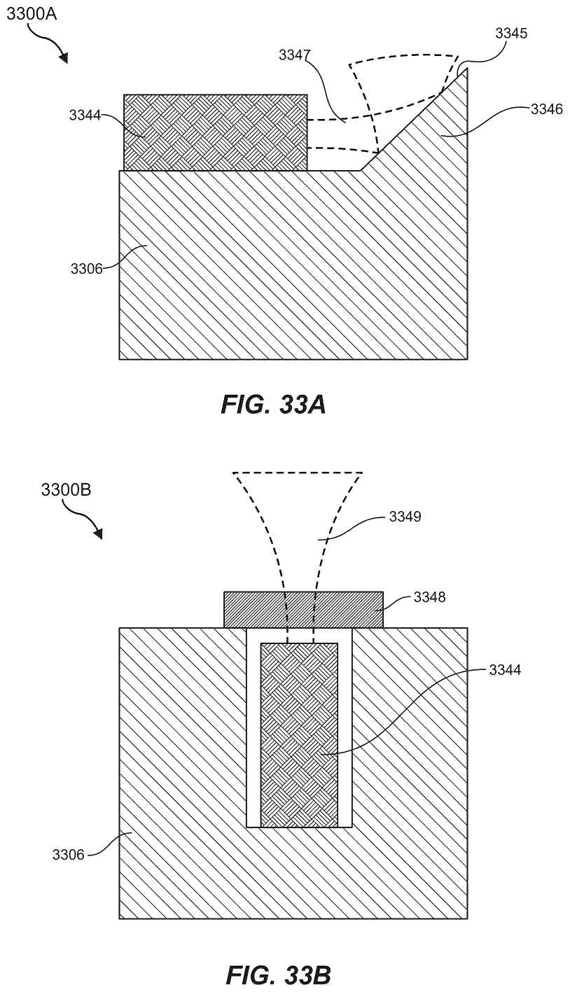

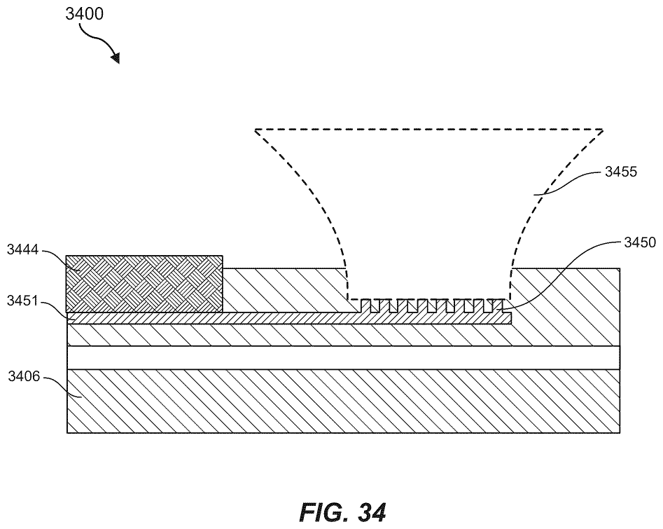

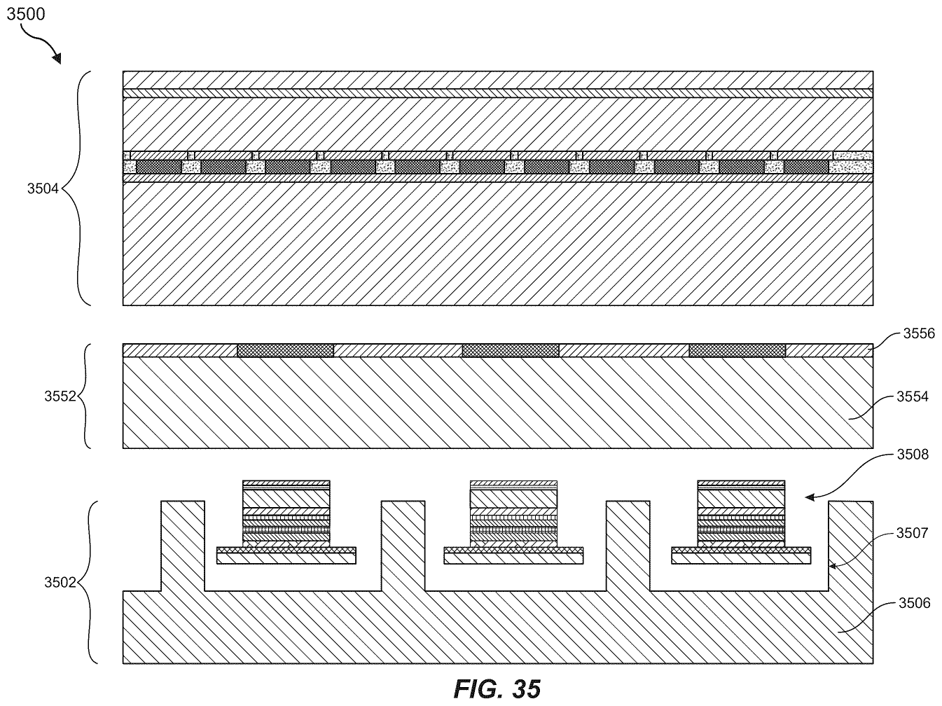

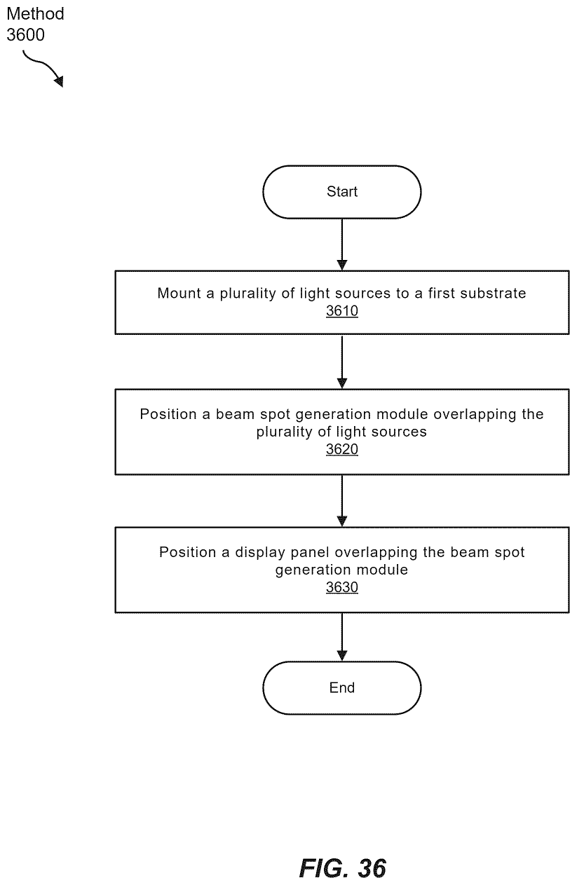

FIG. 28 is a flow diagram illustrating a method 2800 of fabricating a display system according to at least one embodiment of the present disclosure. At operation 2810, a plurality of light sources may be mounted to a first substrate. Operation 2810 may be performed in a variety of ways. For example, the plurality of light sources (e.g., VCSELs or other laser light sources) may be coupled to portions (e.g., within cavities) of the first substrate. The first substrate may include wiring to drive the mounted light sources (see, e.g., FIGS. 18-23 and 27).

At operation 1120, a beam spot generation module may be positioned overlapping the plurality of light sources. Operation 2820 may be performed in a variety of ways. For example, the beam spot generation module may be formed of DOEs and/or HOEs disposed on a second substrate (see, e.g., FIGS. 18, 19, and 27). The second substrate may be laminated on the first substrate overlapping the plurality of light sources such that light from the light sources is redirected by the beam spot generation module to form an array of beams spots.

At operation 2830, an array of color conversion modules may be positioned overlapping the beam spot generation module. Operation 2830 may be performed in a variety of ways. For example, a display panel may be co-fabricated with a color conversion medium having color conversion modules to convert blue light to red and green light or to convert UV light to red, green, and blue light at respective pixel locations. In some examples, each color conversion module of the array of color conversion modules may include a color conversion medium for converting a corresponding beam of light from the beam spot generation module to a converted color (see, e.g., FIGS. 24A-26B).

Accordingly, the present disclosure includes display systems, devices, and methods that include laser-array-based BLUs overlapping display panels. The laser-array-based BLUs with selective zonal illumination capabilities that enable segmented local dimming (i.e., zonal illumination), high directionality, high polarization, and high throughput. Additionally, in some embodiments, the described laser-array-based BLUs may provide redundancy such that multiple light sources may be available to provide light for each pixel.

Accordingly, the disclosed display systems may provide desirable display features while allowing for minimal power usage through selective zonal illumination. For example, local dimming of unused portions of the display area may be utilized to manage power saving and offer a high dynamic range display. A laser-array-based BLU with directional polarized output may provide high light efficiency and focused beam spots at the display panel plane may provide high light throughput. Additionally, accurate (e.g., pixel-level) alignment between the light source module and the beam spot generation module may not be needed, facilitating assembly of the system.

### EXAMPLE EMBODIMENTS

Example 1: A backlight unit includes 1) an array of spatially coherent light sources that emit an initial light color, 2) a beam spot generation module overlapping the array of spatially coherent light sources, and 3) an array of color conversion modules overlapping the beam spot generation module, each color conversion module of the array of color conversion modules including a color conversion medium for converting a corresponding beam of light from the beam spot generation module to a converted color.

Example 2: The backlight unit of Example 1, where the spatially coherent light sources include at least one of VCSELs, edge emitting lasers, fiber lasers, heterogeneously integrated lasers, hybrid-lasers, superluminescent diodes, or nonlinear converted light sources.

Example 3: The backlight unit of Example 2, where each of the VCSELs includes a polarization selection mechanism placed outside of a cavity of the VCSEL or embedded with the cavity of the VCSEL.

Example 4: The backlight unit of Example 3, where the polarization selection mechanism includes at least one of 1) a polarization dependent absorbing, scattering, diffracting, or reflecting material or structure, 2) a polarization dependent phase retarder, 3) a polarization dependent optical refraction or reflecting element, or 4) an etched structure applying asymmetry to the VCSEL operation.

Example 5: The backlight unit of any of Examples 1-4, where the beam spot generation module generates an array of beam spots corresponding to an array of pixels of a display panel.

Example 6: The backlight unit Example 5, where the color conversion modules are arrayed such each color conversion module overlaps a corresponding pixel or sub-pixel.

Example 7: The backlight unit of any of Examples 1-6, where each color conversion module includes one or a more color conversion materials configured to absorb light within a first wavelength range and emit light within a second wavelength range that is different from the first wavelength range.

Example 8: The backlight unit of Example 7, where the one or more color conversion materials include at least one of a quantum dot material, a fluorescent material, a phosphorescent material, a quantum well material, or a semiconductor nanowire material.

Example 9: The backlight unit of any of Examples 1-8, where at least a some of the color conversion modules are overlapped by reflective film stacks that include at least one of high or partial reflective films Example 10: The backlight unit of Example 9, where the reflective film stacks form resonant cavities that include the overlapped color conversion modules.

Example 11: The backlight unit of Example 10, where the resonant cavities recycle pump light received from the beam spot generation module.

Example 12: The backlight unit of Example 10, where the resonant cavities recycle converted light generated in the color conversion modules.

Example 13: The backlight unit of any of Examples 1-12, where at least some of the color conversion modules include polarizers.

Example 14: The backlight unit of Example 13, where the polarizers include at least one of a wire-grid polarizer, a particle polarizer, a multi-stack polarizer, a reflective polarizer or an engineered nano-structured polarizer.

Example 15: The backlight unit of Example 14, where the color conversion modules including the polarizers further include at least one of a reflective polarizer, a waveplate, and one or more reflective coatings.

Example 16: A display system includes a BLU having 1) an array of spatially coherent light sources that emit an initial light color, 2) a beam spot generation module overlapping the array of spatially coherent light sources, and 3) an array of color conversion modules overlapping the beam spot generation module, each color conversion module of the array of color conversion modules including a color conversion medium for converting a corresponding beam of light from the beam spot generation module to a converted color. The display system also includes a display panel overlapping the laser-array-based BLU.

Example 17: The display system of Example 16, where the spatially coherent light sources include VCSELs.

Example 18: The display system of Example 16, wherein the array of spatially coherent light sources includes at least one of edge emitting lasers, fiber lasers, heterogeneously integrated lasers, hybrid-lasers, superluminescent diodes, or nonlinear converted light sources.

Example 19: The display system of any of Examples 16-18, where the beam spot generation module generates an array of beam spots corresponding to an array of pixels of the display panel.

Example 20: The display system of any of Examples 16-19, where each color conversion module includes one or a more color conversion materials configured to absorb light within a first wavelength range and emit light within a second wavelength range that is different from the first wavelength range.

Example 21: A method that includes 1) mounting a plurality of light sources to a first substrate, 2) positioning a beam spot generation module overlapping the plurality of light sources, and 3) positioning an array of color conversion modules overlapping the beam spot generation module, where each color conversion module of the array of color conversion modules includes a color conversion medium for converting a corresponding beam of light from the beam spot generation module to a converted color.

What is claimed is:

1. A method comprising:
creating a metasurface design using a target phase profile of a target wavefront and a library of metasurface elements;
simulating the metasurface design;
determining a wavefront resulting from the metasurface design;
calculating an error between the target wavefront and the determined wavefront; and
generating an updated phase profile using the calculated error.

2. A method comprising:
creating a metasurface design by selecting metasurface elements from a library of metasurface elements based on a first wavefront;
simulating an electromagnetic response of the metasurface design;
measuring a second wavefront based on the metasurface design;
calculating an error between the first wavefront and the second wavefront; and
generating a virtual phase profile by subtracting from the first wavefront, the calculated error between the first wavefront and the second wavefront.

3. The method of claim 2, wherein the library of metasurface elements comprises a plurality of nanostructure sizes and orientations.

4. The method of claim 2, wherein the simulation of the electromagnetic response is performed using an entire area of the metasurface design.

5. The method of claim 2, wherein measuring the first wavefront and the second wavefront is performed by a wavefront apparatus.

6. The method of claim 2, wherein the error between the first wavefront and the second wavefront is computed in both amplitude and phase.

7. A display system, comprising:
a backlight unit (BLU) that comprises:
an array of spatially coherent light sources; and
a beam spot generation module overlapping the array of spatially coherent light sources; and
a display panel overlapping the BLU,
wherein light from the array of spatially coherent light sources is diffracted by the beam spot generation module to produce an array of beam spots corresponding to an array of pixels in the display panel.

8. The display system of claim 7, wherein the spatially coherent light sources comprise vertical-cavity surface-emitting lasers (VCSELs).

9. The display system of claim 8, wherein each of the VCSELs includes a polarization selection mechanism placed outside of a cavity of the VCSEL or embedded within the cavity of the VCSEL.

10. The display system of claim 9, wherein the polarization selection mechanism includes at least one of:
a polarization dependent absorbing, scattering, diffracting, or reflecting material or structure;
a polarization dependent phase retarder;
a polarization dependent optical diffraction, refraction or reflecting element; or
an etched structure applying asymmetry to the VCSEL operation.

11. The display system of claim 10, wherein:
the optical diffraction, refraction, or reflecting element comprises at least one of a lens, a curved mirror, a meta-lens, and a meta-mirror; and
the etched structure comprises an etched bar, etched grating or semi-periodic structures.

12. The display system of claim 8, wherein the VCSELs are each configured with one set of electrodes in contact with one or more layers above a gain medium of the VCSEL and another set of electrodes in contact with one or more layers below the gain medium to allow injection current to go through the gain medium and generate light.

13. The display system of claim 12, wherein:
the one or more layers above the gain medium include at least a portion of at least one of a cladding, a focusing layer, or multi-stack of partial reflectance/high reflectance layers; and
the one or more layers below the gain medium include at least a portion of at least one of another cladding layer, an HR layer, or a substrate.

14. The display system of claim 8, wherein wavelength conversion modules overlap at least some of the VCSELs to change wavelengths of light emitted by the overlapped VCSELs.

15. The display system of claim 14, wherein the wavelength conversion modules comprise one or more nonlinear materials configured to convert non-visible light or light of some wavelength to visible light of a desired wavelength.

16. The display system of claim 14, wherein the wavelength conversion modules perform at least one of:
wavelength conversion processes to convert NIR light to visible light via at least one of second harmonic generation, third harmonic generation, high-order harmonic generation, or four-wave mixing; or
wavelength conversion processes to convert higher-frequency light into lower-frequency light via at least one of parametric down conversion or four wave mixing.

17. The display system of claim 7, wherein the array of spatially coherent light sources comprises at least one of edge emitting lasers, fiber lasers, heterogeneously integrated lasers, hybrid-lasers, superluminescent diodes, or nonlinear converted light sources.

18. The display system of claim 7, wherein the light from the array of spatially coherent light sources is:
propagated through a light-guiding medium before being redirected by one or more reflective, diffractive and/or transmissive optical elements; and
reshaped by a reflective, diffractive or transmissive optical element that changes the wavefront of the beam.

19. The display system of claim 7, wherein the light from the array of spatially coherent light sources is propagated through a light-guiding channel before being redirected into vertical direction through an out-coupler.

20. The display system of claim 19, wherein the out-coupler comprises at least one of a waveguide grating coupler, a metasurface, or a holographic diffraction element.
